(19) United States
(12) Patent Application Publication
(10) Pub. No.: US 2005/0223111 A1
(43) Pub. Date: Oct. 6, 2005

(54) Secure, standards-based communications across a wide-area network

(76) Inventors: Nehru Bhandaru, Sudbury, MA (US); Michael Cook, Lexington, MA (US); Webster Gaidos, Stow, MA (US); Susan Hares, Saline, MI (US); Owais U. Hassan, Andover, MA (US); Michael Carrafiello, Hudson, NH (US); Albert Lew, Medford, MA (US); David Morris, Lexington, MA (US); Martin Mueller, Shrewsbury, MA (US); Michael Vakulenko, Zichron Yaacov (IL)

Correspondence Address: PERKINS COIE LLP, P.O. BOX 2168, MENLO PARK, CA, 94026, US

(21) Appl. No.: 10/982,598

(22) Filed: Nov. 4, 2004

Related U.S. Application Data
(60) Provisional application No. 60/516,997, filed on Nov. 4, 2003.

(51) Int. Cl. G06F 15/16

(52) U.S. Cl. 709/236; 709/232

(57) ABSTRACT

The invention includes systems and methods to extend security from enterprise networks to wide-area networks by allowing secure connectivity to the enterprise layer 2 network across a wide-area layer 3 network, such as the Internet

### CLAIM OF PRIORITY

This application claims priority to U.S. Provisional Application 60/516,997, entitled SECURE, STANDARDS-BASED LAYER 2 COMMUNICATIONS ACROSS A WIDE-AREA LAYER 3 NETWORK, filed Nov. 4, 2003, which is hereby incorporated by reference in its entirety.

### FIELD OF THE INVENTION

The invention relates to the field of computer networking, and more specifically, to data encryption techniques used in conjunction with networking protocols.

### BACKGROUND

Enterprises typically seek to provide remote connectivity to the enterprise network for their employees. For example, remote connectivity may be used by employees in the following physical locations:
Employee homes
Branch offices
WISPs
Hotels
Pay phones

The problem is that remote connectivity requires an enabling overlay infrastructure. This imposes burdens on the IT staff, adding maintenance and capital expenses on top of existing enterprise infrastructure, and generally requires employees to alter their pattern of computer activity depending on their physical locations—i.e., whether they use the enterprise network from within the enterprise or remotely. Moreover, remotely connected employees may be restricted in terms of resources they can access; unless special measures are taken by the IT staff, employees often are denied remote access to resources they may routinely use when located within the enterprise.

Enterprises typically provide VPN services to their employees to facilitate remote access to the enterprise network. A VPN that operates at layer 3 allows users of the VPN to utilize the high speed of their broadband Internet connections to connect to the enterprise. Since the VPN operates at layer 3, it works independently of whether employees use a cable modem, DSL, fixed wireless, or some other means as their broadband connection to the Internet.

One problem with the VPN approach is the requirement that users adopt different behaviors when connecting to the enterprise remotely as compared with the familiar pattern of activity local to the enterprise. For instance, local users may either plug into the existing network with an Ethernet cable, or may use an 802.11 enterprise wireless network. However, when users are at a remote site such as their homes, an airport, or a WiFi hotspot, they are required to start their VPN client in order to connect to the enterprise.

For the system administrator, a VPN generally involves a separate remote-access infrastructure that is deployed independent of the local enterprise edge-access infrastructure. Since the VPN server typically provides only layer 3 connectivity, many legacy layer 2 applications do not work across the VPN. While these legacy applications can be enabled to work across layer 3 networks, e.g., through use of application layer gateways, such additional gateways require even further maintenance and capital expenses from the IT staff.

Multiple solutions exist for providing layer 2 connectivity to the enterprise so that fall access to enterprise resources can be made available remotely. These solutions include:
Dialup
DSL
Carrier wireless data services over licensed spectrum
Proprietary layer 2 clients
Wireless access points that perform double encryption

Dialup POTS access for providing layer 2 connectivity can be provided with RAS products. However, dialup is subject to lost connections, consumes a phone line at the home, and has limited bandwidth.

DSL access can provide layer 2 connectivity to the enterprise if the enterprise owns the DSLAMs used to terminate the DSL lines. However, for an enterprise to provide DSL layer 2 connectivity involves considerable expense, the largest of which is providing copper lines from employees to the enterprise. DSL access may be leased from carriers, but this, too, involves high cost. Furthermore, DSL access often cannot be universally provided to employees due to distance restrictions (since DSL will not operate beyond a certain distance) between the employee's DSL line and the DSLAM.

Carrier wireless data services over licensed spectrum include high-speed cellular data services provided by carriers such as Sprint and Verizon. These services are not universally available. Also, carrier wireless data services are (currently) limited in bandwidth compared to 802.11 and Ethernet.

Proprietary layer 2 clients have existed for many years to provide secure wired and wireless LAN access to enterprise resources using encrypted Ethernet, ATM, and 802.11 technologies. The problem with these approaches is that they involve a dedicated layer 2 wide-area network in order to provide wide-area connectivity back to the enterprise. 802.11 technology cannot be deployed over the wide area due to its limited (300 ft indoor, 1 km outdoor) range. Ethernet has been deployed only in limited wide-area applications, and due to the same challenge of providing ubiquitous coverage as described above in the DSL scenario. ATM has been implemented over wide-area networks, but providing ATM services to employees for remote access is expensive and generally not instantly available, since the provisioning of dedicated ATM lines to end users is a slow and time-consuming process.

Another possibility for providing layer 2 connectivity to an enterprise network is with traditional access points that implement “double encryption.” The first phase of encryption is over the wireless medium, and uses existing secure layer 2 protocols such as 802.11i and WPA. The second phase of encryption is over the wired side of the access point. Before encryption begins, however, the access point must be configured to bridge the 802.11 traffic to 802.3 Ethernet, and then utilize a layer 2 tunneling protocol over IP such as L2TP to encapsulate the traffic in IP in order to ready that traffic for transit across a layer 3 Internet. The access point may then encrypt the traffic using IPSec. The traffic may be terminated within the enterprise by an IPSec VPN concentrator, and the L2TP headers stripped out by a router or the VPN concentrator. The problem with this approach is that a separate remote access infrastructure in the form of a VPN concentrator is still required by the enterprise in order to provide remote connectivity to the end user. This approach may also suffer from poor performance and/or high cost, since it is computationally expensive for an access point to provide double encryption as described above. Furthermore, the encapsulation of data in L2TP and then again in IPSec reduces performance of the link between the access point and VPN concentrator. The additional overhead of this mechanism is likely to have adverse effects on time-sensitive applications such as VoIP, and may also reduce the effective throughput available over the wide-area connection between the access point and the VPN concentrator.

The advent of ubiquitous, low-cost wireless LAN NIC cards and access points for SOHO/consumer use has spurred the development of secure layer 2 protocols such as 802.11i and WPA for use enterprise environments, which generally need more advanced security. Both 802.11i and WPA provide strong user authentication and encryption for wireless communications between the wireless client and the wired network.

Yet another possibility is to use a RF/Wireless Mesh-based distribution service to provide Layer 2 connectivity to the enterprise network. In this model, a wireless client may associate with an access point which forwards the traffic via its RF interfaces to other access points. These in turn may forward the traffic to other access points until the traffic enters the wired network. This point of entry is termed wireless integration service portal in 802.11 terminology. One non-optimal approach to secure the traffic over the air is to use hop-by-hop protection (encryption, and integrity) which consumes CPU and memory resources at each hop.

Current 802.11 standards and practice specify an authenticator component of an AP that derives or obtains shared secret key information known as PMK (Pair-wise Master Key) to protect the traffic between a wireless client and the AP over the air once it is associated. This PMK is a security binding of trust between the wireless client, the authenticator and the trusted authentication server for their domain. When the client roams or re-associates to another AP in the same ESS and/or authentication domain, the client is forced to authenticate again adding latency to the roaming process. This latency could potentially interrupt the session (e.g. voice) between the wireless client and another device in the network.

Currently, the security of the wireless LAN protocols is restricted to enterprise usage by clients within the enterprise campus and cannot be extended across a wide-area layer 3 Internet. This confinement of wireless security to the enterprise campus has at least two sources:
1. The security is terminated locally at the access point, i.e., the wired interface of the access point transmits data free of security restrictions. Therefore, most access points, as well as many lightweight access point/wireless switch combinations that terminate security at the lightweight access point, are not able to securely transport 802.11 layer 2 traffic across a wide-area network.
2. There is currently no accepted method for transporting a secure layer 802.11-based protocol, such as 802.11i or WPA, across a wide-area network.

### SUMMARY OF THE INVENTION

Embodiments of the invention extends security from enterprise networks to wide-area networks by allowing secure connectivity to the enterprise layer 2 network across a wide-area layer 3 network, such as the Internet. The benefits of this approach for providing secure layer 2 access to the enterprise network include:
Unified infrastructure.
Allowing enterprises to utilize either lightweight or heavyweight access points.
Extending the layer 2 enterprise network to the home, and public Internet facilities.
Option for simultaneous access to both remote enterprise and local resources such as printers, IP fax services, etc.
Option for access to the Internet only through the enterprise to leverage enterprise-based IDS, firewall, and virus scanning.
Simultaneous co-existence of lightweight and heavyweight access points within the enterprise campus, including seamless mobility between these devices.
Standards based secure layer 2 wired connectivity.
Simpler VoIP to cellular roaming.

The present invention provides a unified infrastructure that allows enterprises to utilize the same wireless LAN switch for both local-campus wireless access as well as remote access. This feature saves both capital and operational expenditures as well as demands on technical support. It also supports transparent connectivity to end users, by ensuring that the behaviors for remote connectivity and local enterprise connectivity remain the same. The unified infrastructure also facilitates availability to layer 2 networking protocols to remote users, thereby providing the full capability of the enterprise campus network to the remote users. This includes extending any policy-based layer 2 capability that the enterprise may have implemented within its campus to the remote users. These and other aspects of the invention are further described herein.

### BRIEF DESCRIPTION OF THE DRAWINGS

FIG. 1 illustrates an STA—AP—L2/L3 Network—WVLAN in accordance with embodiments of the invention.

FIG. 2 illustrates Multiple types of Encryption in accordance with embodiments of the invention.

FIG. 3 illustrates and embodiment of RNP protocol

FIG. 4 illustrates an embodiment of IP in IP tunnel and Embodiment of GRE tunnel

FIG. 5 illustrates embodiment of MPLS Tunnel

FIG. 6 illustrates embodiment of TE embodiment of Differentiated Services TE tunnel

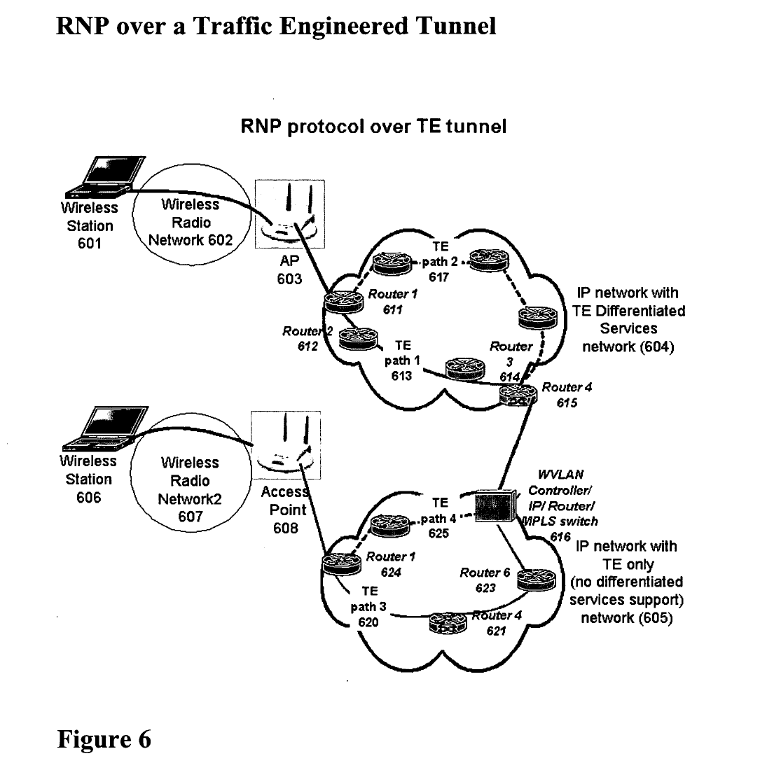

FIG. 7 illustrates an RNP protocol header in accordance with embodiments of the invention.

FIG. 8 illustrates an RNP protocol data stream into 5 sub-tunnels via the header in accordance with embodiments of the invention.

FIG. 9: 3 illustrates embodiments of the RNP virtual client (RRP) in accordance with embodiments of the invention.

FIG. 10 illustrates the operation of and packet flow in a representative WiFi VPN client in accordance with embodiments of the invention.

FIG. 11 illustrates Layer 2 encrypted in 802.11i, WPA, WPA2, RC-4 non-encrypted, in accordance with embodiments of the invention.

FIG. 12 illustrates imprinting steps in accordance with embodiments of the invention.

FIG. 13 illustrates a state machine for Access Point in accordance with embodiments of the invention.

FIG. 14 illustrates a message format for RNP-RC messages in accordance with embodiments of the invention.

FIG. 15 illustrates a per WVLAN per Access Point State machine in accordance with embodiments of the invention.

FIG. 16 illustrates a Security model with its security key of the tuple (VLAN, BBSID, Security type) in accordance with embodiments of the invention.

FIG. 17 illustrates LEK/REK encryption of the unicast, broadcast and multicast traffic from the security keys in accordance with embodiments of the invention.

FIG. 17a illustrates Broadcast/Multicast separation in accordance with embodiments of the invention.

FIG. 17b illustrates Unicast Separation in accordance with embodiments of the invention.

FIG. 18 illustrates RNP Virtual Client with LEK/REK encryption in accordance with embodiments of the invention.

FIG. 18a illustrates RNP Virtual Client—LEK, REK Derivation and RNP Virtual Client Encryption in accordance with embodiments of the invention.

FIG. 18b illustrates RRP Client—LEK/REK Derivation and RNP Virtual Client

FIG. 18c illustrates RRP Client Traffic Decryption by Local AP and WLAN Controller in accordance with embodiments of the invention.

FIG. 18d illustrates RRP Client Traffic Encryption—By Local AP and WLAN Controller in accordance with embodiments of the invention.

FIG. 19 illustrates LEK and REK Encrypted frame formats in accordance with embodiments of the invention.

FIG. 21 illustrates Wifi VPN in Wireless Mesh in accordance with embodiments of the invention.

FIG. 22 illustrates PMK Sharing—Example PMK/S-PMK Flows in accordance with embodiments of the invention.

FIG. 23 illustrates PMK Sharing Packet Flow in accordance with embodiments of the invention.

FIG. 24: illustrates Protocol PDUs for RNP-RC packets in accordance with embodiments of the invention.

FIG. 25: illustrates Protocol PDUs for RNP RC packets in accordance with embodiments of the invention.

FIG. 26: illustrates Protocol PDUs for RNP RC packets in accordance with embodiments of the invention.

FIG. 27: illustrates Protocol PDUs for RNR_RC packets in accordance with embodiments of the invention.

FIG. 28: illustrates Protocol PDUs for RNR-RC packets #5 in accordance with embodiments of the invention.

FIG. 29: illustrates Protocol PDUS for RNR_RC packets #6 in accordance with embodiments of the invention.

FIG. 30: illustrates Protocol Exchanges for RNP_RC

FIG. 31: illustrates Protocol PDUs for RNP_SM packets #1 in accordance with embodiments of the invention.

FIG. 32: illustrates RNP PDUs for RNP_SM packets #2 in accordance with embodiments of the invention.

FIG. 33: illustrates RNP PDUs for RNP_SM packets #3 in accordance with embodiments of the invention.

FIG. 34: illustrates RNP PDUs for RNP_SM packets #4 in accordance with embodiments of the invention.

FIG. 35 illustrates RNP PDUs for RNP_SM packets #5 in accordance with embodiments of the invention.

FIG. 36 illustrates RNP PDU Exchanges for RNP-SM sub-protocol

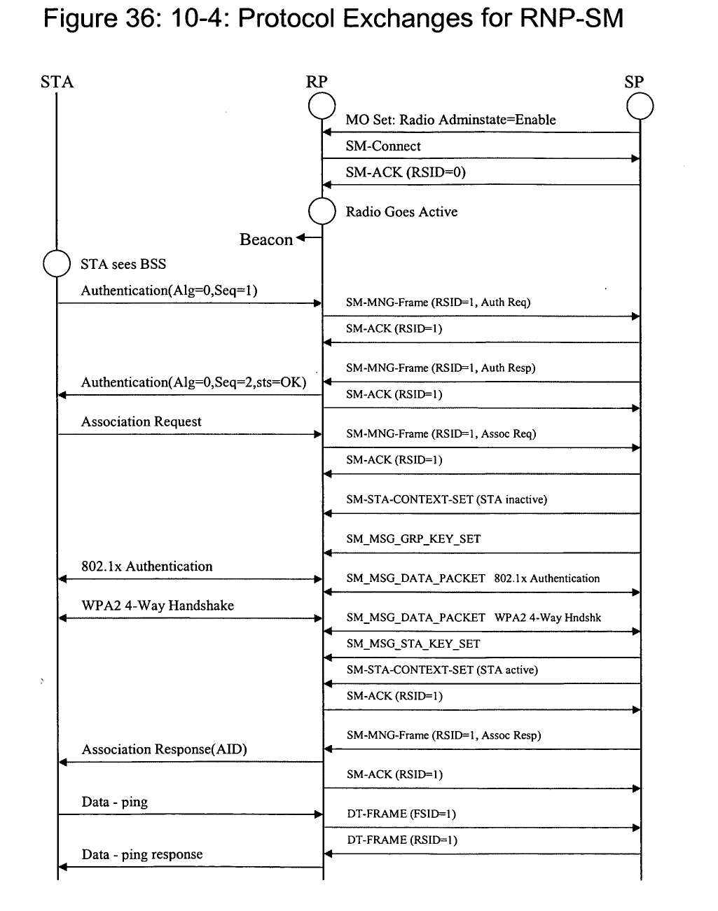

FIG. 37 illustrates RNP Exchanges for 802.1X authentication

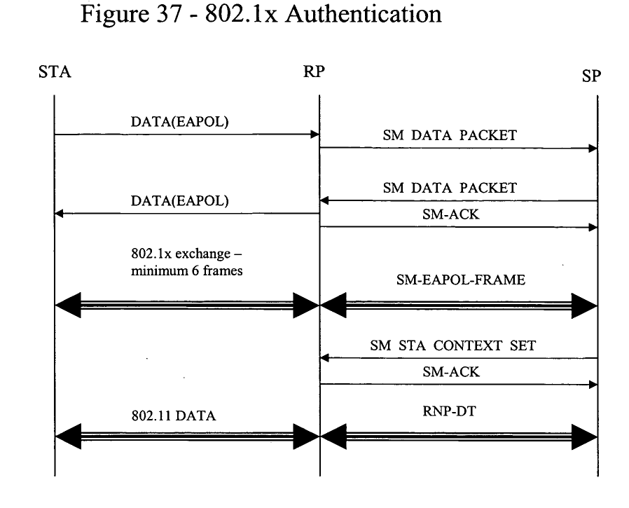

FIG. 38 illustrates RNP packets for RNP-DT sub-protocol in accordance with embodiments of the invention.

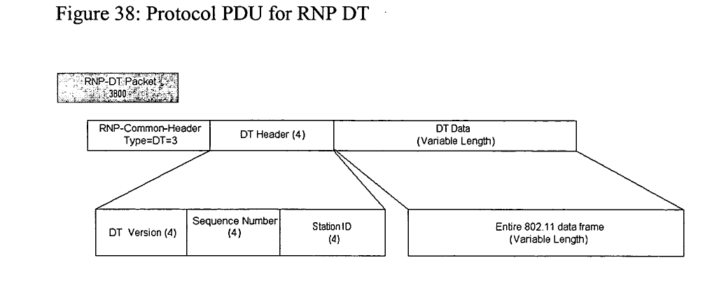

FIG. 39 illustrates RNP packets for RNP-DF sub-protocol (#1) in accordance with embodiments of the invention.

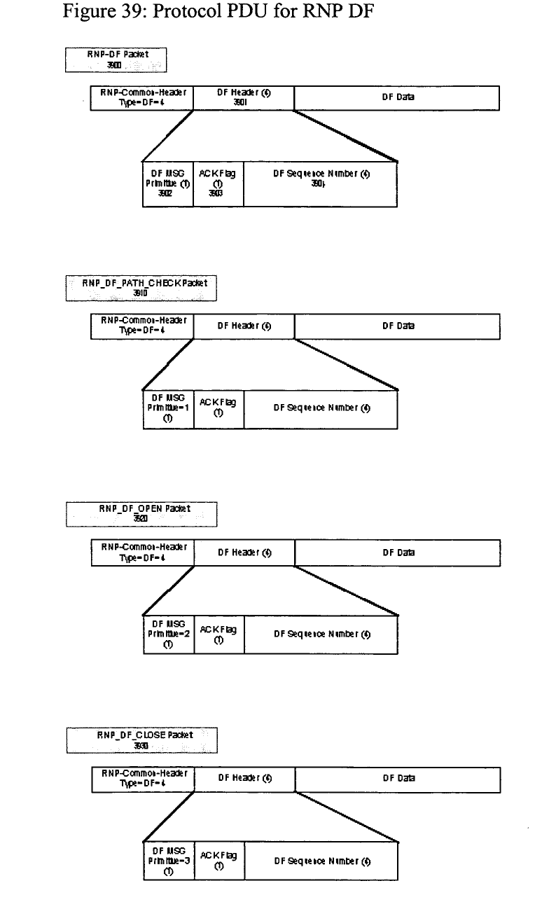

FIG. 40 illustrates RNP packets for RNP-DF sub-protocol (#2) in accordance with embodiments of the invention.

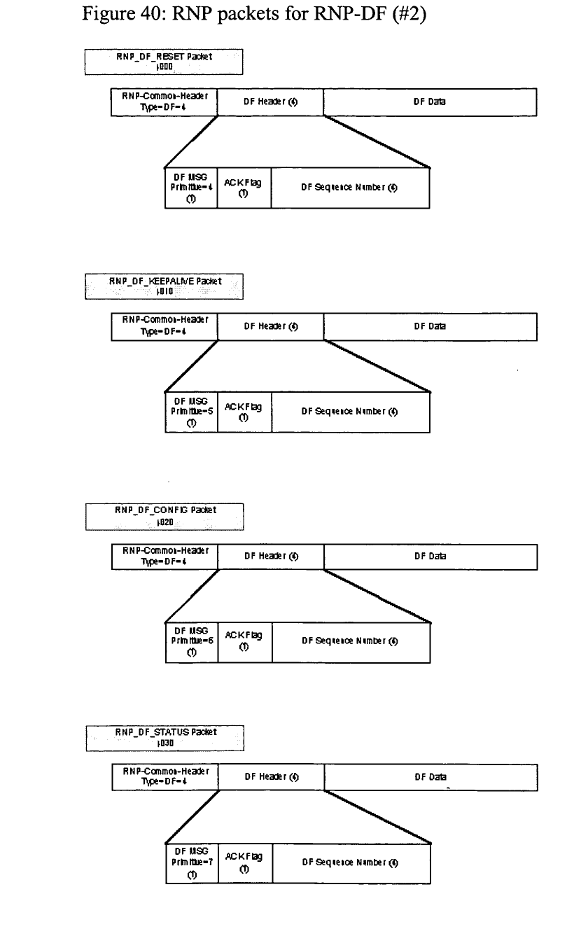

FIG. 41 illustrates RNP packets for RNP-WP sub-protocol in accordance with embodiments of the invention.

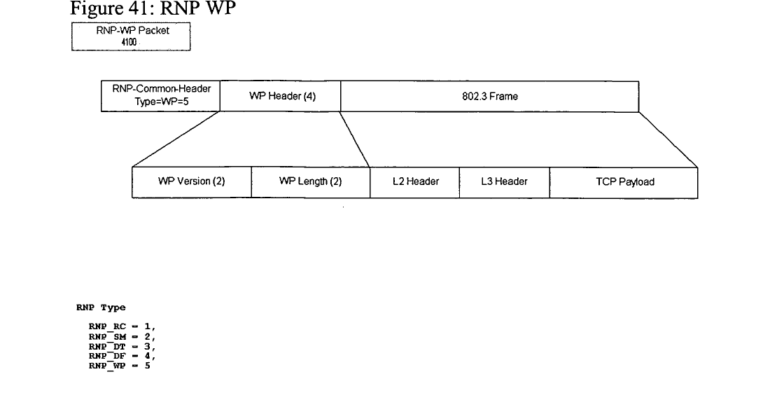

FIG. 42 illustrates RNP packet flow Showing SM, and DF for Association in accordance with embodiments of the invention.

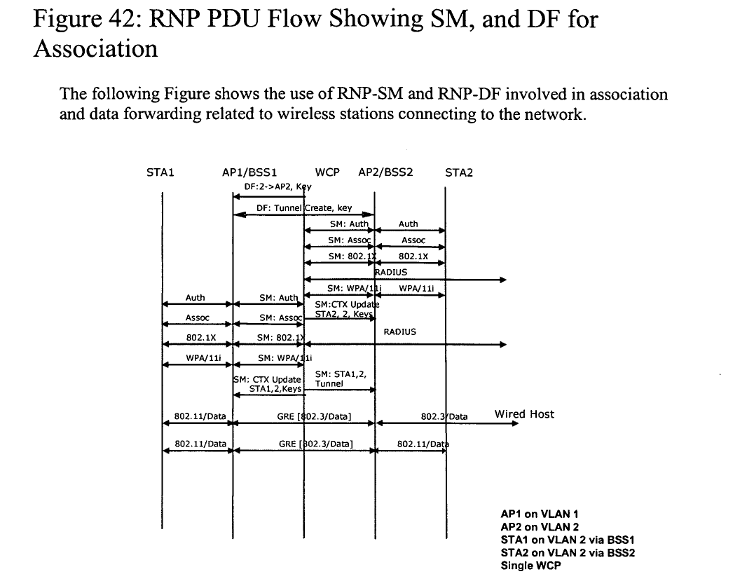

FIG. 43 illustrates RNP packet flow showing re-association in accordance with embodiments of the invention.

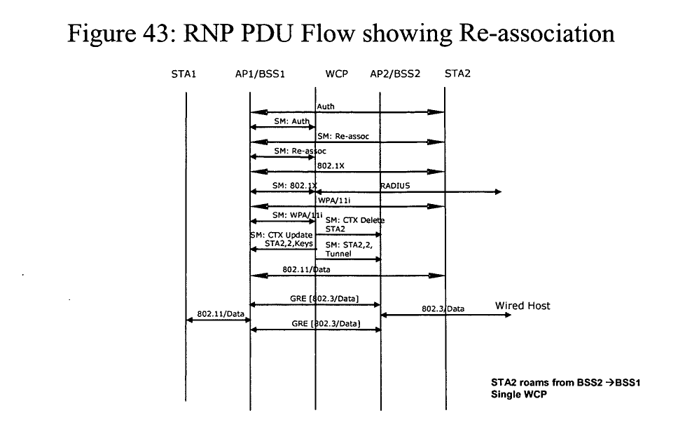

FIG. 44 illustrates RNP packet flow showing: imprinting and RNP Security in accordance with embodiments of the invention.

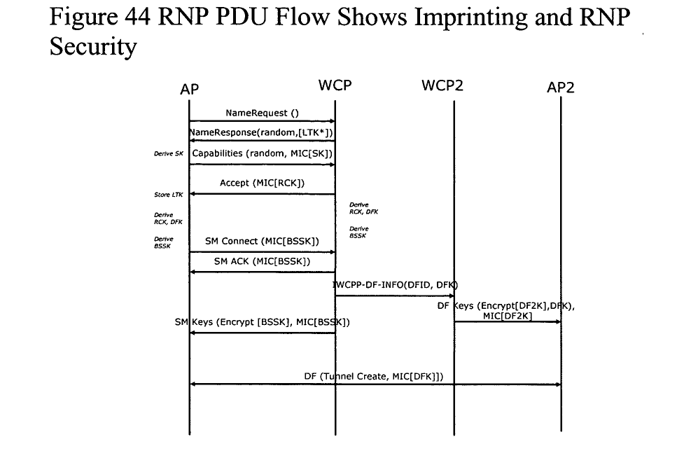

FIG. 45 illustrates RNP PDU Flow for RNP-WP in accordance with embodiments of the invention.

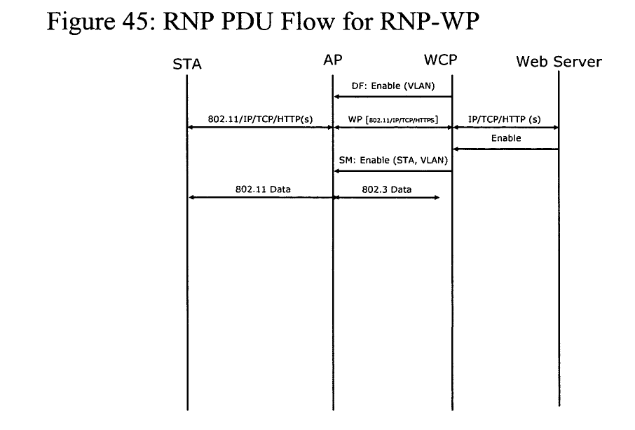

FIG. 46 illustrates Enterprise Authentication Over Shared WISP Infrastructure in accordance with embodiments of the invention.

FIG. 47 illustrates Enterprise Authentication Over Shared WISP in accordance with embodiments of the invention.

### DESCRIPTION OF THE INVENTION

In accordance with the present invention, a WiFi VPN extends security from an enterprise campus to a wide-area network by allowing secure connectivity to the enterprise layer 2 network across a wide-area layer 3 network, such as the Internet. Embodiments of the invention may include multiple components, which may operate independently or in conjunction. Combinations of such components support a flexible framework for a WiFi VPN.

Extension of Security Provisions from an Enterprise Network Across a Wide-Area by Allowing Security Connectivity for an Enterprise Layer 2 Network Across a Layer Three Network.

In embodiments of the invention, security provisions for an enterprise network are extended by tunneling 802.11 management and optionally layer 2 data traffic for a wireless station (STA) to a wireless controller/switch using a routed protocol. Non-limiting examples of tunneling protocols that may be routed include:
UDP over IP, or
IP in IP,
IP-sec,
GRE encapsulation, or
MPLS

Other examples shall be apparent to those skilled in the art.

The tunnel is between the lightweight access point AP and the WLAN switch (Layer2/Layer3), or the wireless client and the WLAN switch. Wireless encryption is terminated on the switch/controller or on the AP. Bridging to 802.3 can happen on the Switch/Controller or the AP.

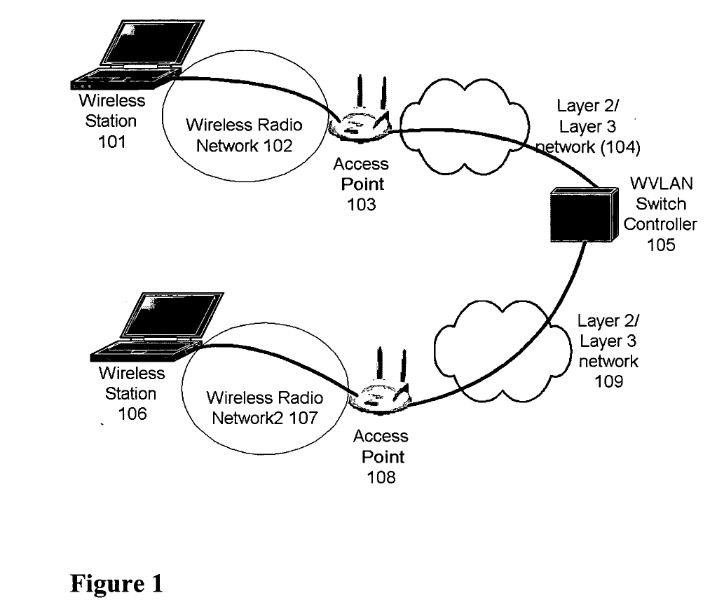

FIG. 1 shows the logic of this method. In FIG. 1, the termination of the WiFi VPN at WLAN switch (Figure point 105). Wireless station (101) connects to an Access Point (103) across Wireless network (102). At the lightweight Access point (103), a tunnel is created between the AP (103) and Wireless Controller (105) over a Layer2/Layer 3 network (104). In the same manner, Wireless Point 106 connects over a second wireless network (107) to an lightweight Access Point (108). From LWAP (108) to the wireless control (105), a tunnel is created over the IP network (109).

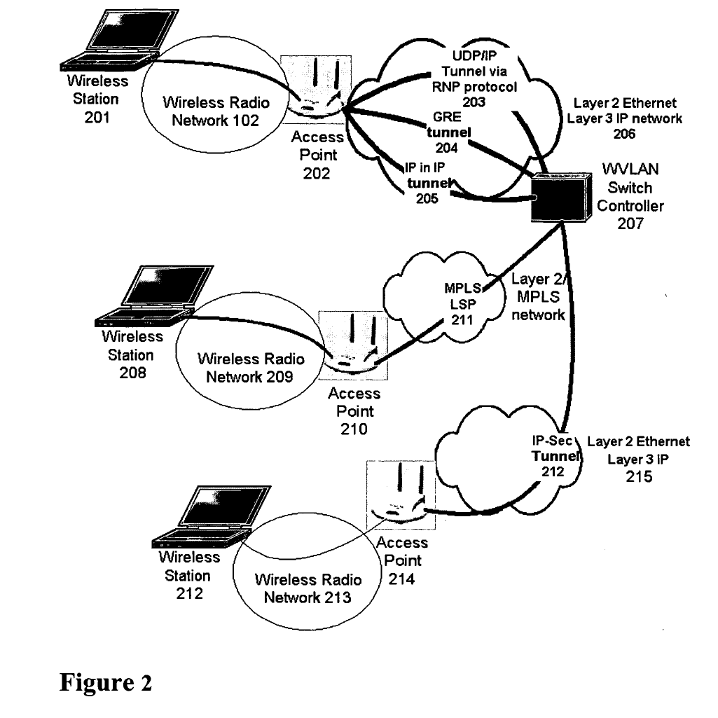

FIG. 2 shows a non-limiting embodiment of this method of creating and using tunnels between several lightweight Access Points (LWAP) (202, 210, 214) and a Wireless Controller switch/router (207) using a variety of protocols. In the non-limiting example illustrated in FIG. 2, the LWAPs connect several wireless stations (201, 208, 212) to the Internet. FIG. 2 shows 5 types of tunnels: UDP/IP tunnel (203), GRE Tunnel (204), IP in IP tunnel (205), MPLS Label-Switched-Path (LSP) (211), and an IP-Sec (212) running across different networks. These are presented for example purposes only; many alternatives shall be apparent to those skilled in the art. FIG. 2 illustrates two non-limiting examples: two Ethernet/IP networks [205, 215] and one MPLS core with IP edge (211).

This is accomplished, in one embodiment, by encapsulating 802.11 data packets within a lightweight WiFi VPN protocol that rides on top of UDP/IP. In embodiments, security is provided by the 802.11 -based standards-based security protocols such as WPA and 802.11i. Encapsulation of the layer 2 packets into the WiFi VPN protocol is performed by either a lightweight access point or virtual interface client software within a PC, PDA or VoWLAN phone. WiFi VPN traffic can then be sent securely to the wired interface of a wireless LAN switch, which allows the traffic to be unencrypted and bridged to an enterprise wired networks. In embodiments, the lightweight protocol running over UDP/IP is the Remote Network Protocol (RNP) that communicates between either the lightweight access point and the WVLAN switch, or the wireless client and the WVLAN switch.

Separation of AP management, Station Management, Data Tunneling, Captive Portal, and Data Forwarding Endpoints

This invention provides a method to separate AP Management (RC), Station Management (SM), Data Tunneling (DT), Captive Web Portal, and Data Forwarding control endpoints. In one embodiment of the invention, the DF endpoints may terminate on other APs or Switches or other devices not necessarily co-located with the Wireless Controller.

In embodiments of the invention, the tunneling of management and data traffic via the RNP protocol may use one or more of the following sub-tunnels:
RNP-RC—radio control,
RNP-SM—station management,
RNP-DT—Data Tunneling,
RNP-WP—Captured portal, and
RNP-DF—Data forwarding control

In embodiments of the invention, the RNP protocol is extensible with respect to further addition of other types of sub-tunnels.

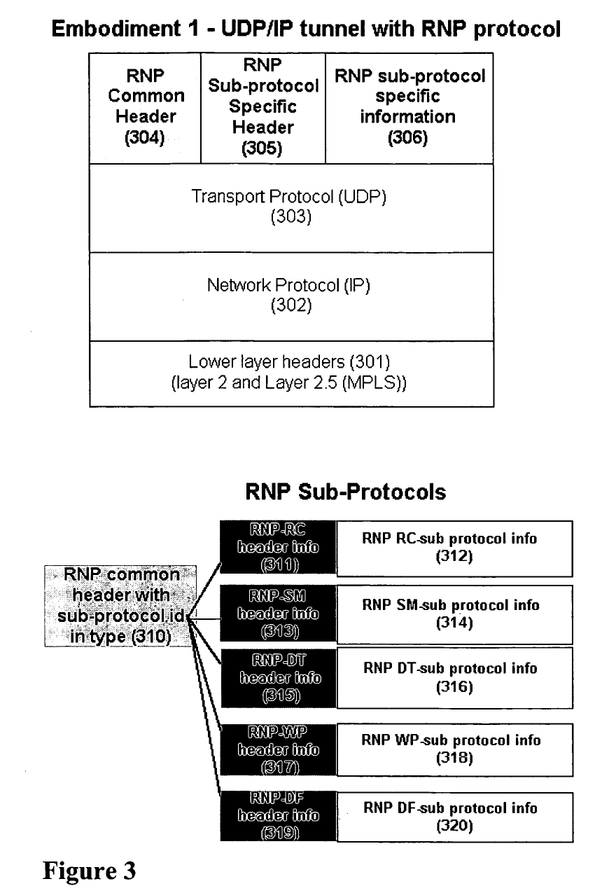

FIG. 3 shows the packet encapsulation of RNP protocol header (304) following the UDP header (303), following the IP header (302), over a lower layers headers (MPLS and/or Ethernet header (301). The RNP protocol header has three parts: RNP common header (304), RNP sub-protocol header (305), and RNP sub-protocol specific data (305). The RNP header specifies the sub-protocol in the type field.

FIG. 3 also shows how the common header splits the protocol into separate sub-protocol streams with sub-protocol headers and data associated with that sub-protocol:
RNP-RC: RNP common header (310), RNP-RC sub-protocol header (311), and RNP-RC sub-protocol data (312),
RNP-SM: RNP common header (310), RNP-SM sub-protocol header (313), RNP-SM sub-protocol data (314),
RNP-DT: RNP common header (310), RNP-DT sub-protocol header (315), RNP-DT sub-protocol data (316)
RNP-WP: RNP common header (310), RNP-WP sub-protocol header (317), RNP-WP sub-protocol data (318)
RNP-DF: RNP common header (310), RNP-DF sub-protocol header (319), RNP-DF sub-protocol data (320)

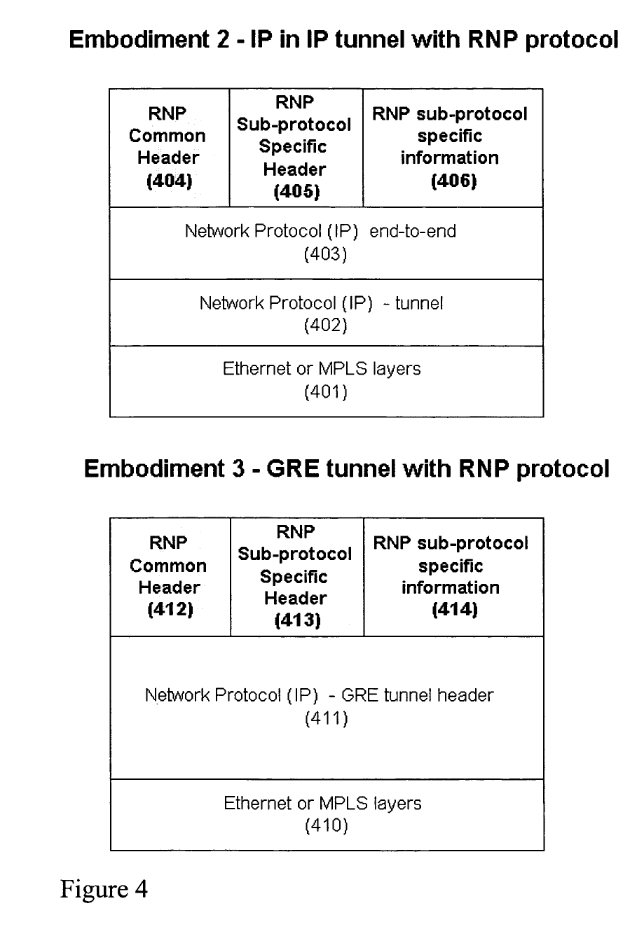

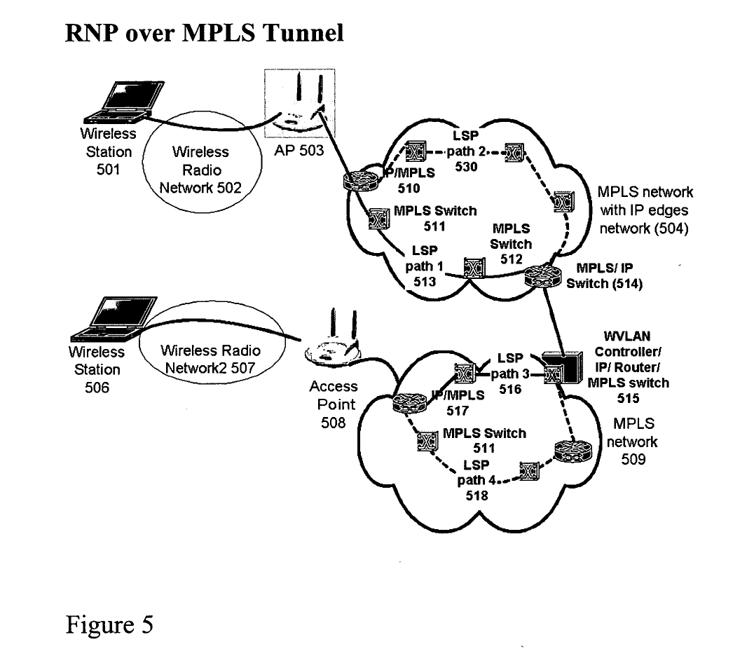

FIG. 4 shows embodiments of this invention with the RNP protocol running over an IP-in-IP tunnel or a GRE tunnel. The RNP protocol header (404, 405, 406) follows the tunnel header for IP in IP (402, and 403). FIG. 4 also shows an embodiment of the invention with a GRE tunnel header (411) in front of the RNP headers (412, 413, 414). FIG. 5 shows an embodiment of the RNP protocol running over a MPLS Label Switched path as a virtual tunnel and the RNP protocol running over a Differentiated Services logical tunnel based on forwarding queues.

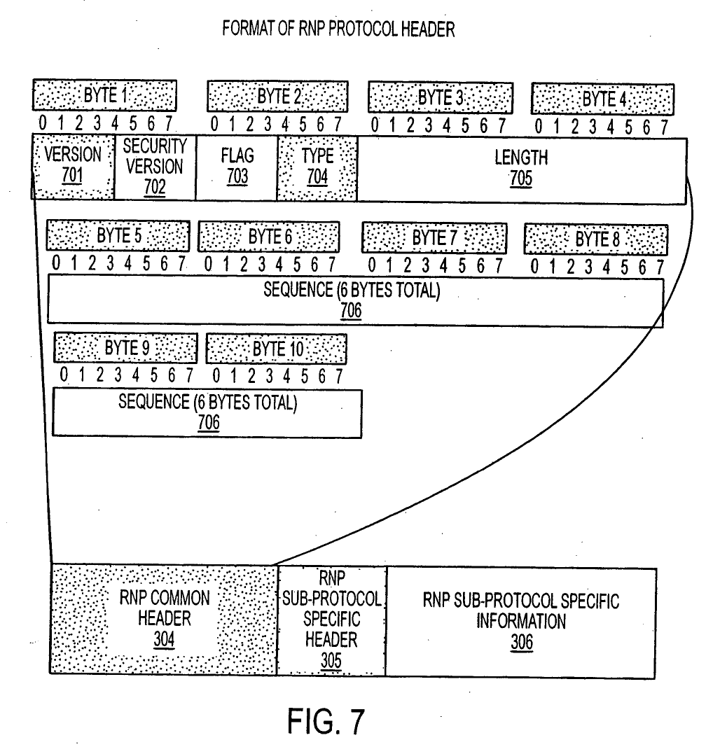

FIG. 7 shows an embodiment of the RNP protocol's common header version 1.0 of the RNP protocol. FIG. 7 expands the field 304 from FIG. 3 to show the actual header fields: version (701), security version (702), flag (703), type (704), length (705), and sequence (706). The type field contains the sub-protocol types (RNP-RC, RNP-SM, RNP-DT, RNP-WP, RNP-DF).

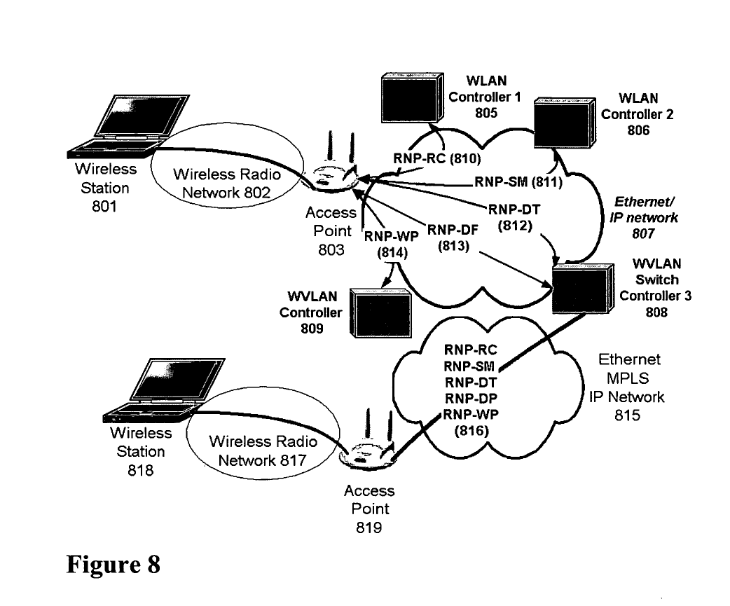

FIG. 8 demonstrates how these RNP sub-protocol streams can split the operation of the lightweight access point (LWAP) over different tunnels. In FIG. 8 wireless station 801 communicates with LWAP 803 over wireless network (802). Using the RNP protocol over tunnel, LWAP 803 sends one or more of the following:
the radio control information sent to WLAN controller 1 (805) using RNP-RC messages,
the station management information to WLAN controller 2 (806) using RNP-SM,
the data is sent WLAN controller 3 (808) using RNP-DT and RNP-DF messages,
Captive Web portal information is sent to WLAN controller (808) via RNP-WP messages,

FIG. 8 also shows a tunnel from a LWAP device (819) to the WLAN controller 3 (809) that carries all RNP messages (816) across a layer2/layer3 network (815).

Extension of the Tunneling Protocol to a Virtual Interface at Client (a WiFi VPN client).

Embodiments of the invention extend the tunneling protocol to build a virtual interface at the client, and extend the tunneling protocol to that client. The virtual interface concept applies to clients with a wireless as well as a wired (Ethernet) network interface.

Some such embodiments create a WiFi VPN that uses 802.11 technology across a Layer 3 network. As non-limiting examples, the station can be a PC, PDA or VoIP phone. Other suitable instantiations shall be apparent to those skilled in the art. The WiFi VPN client encrypts by using WPA, 802.11i, or another suitable encryption protocol, and then encapsulates in the Remote Network Protocol (RNP).

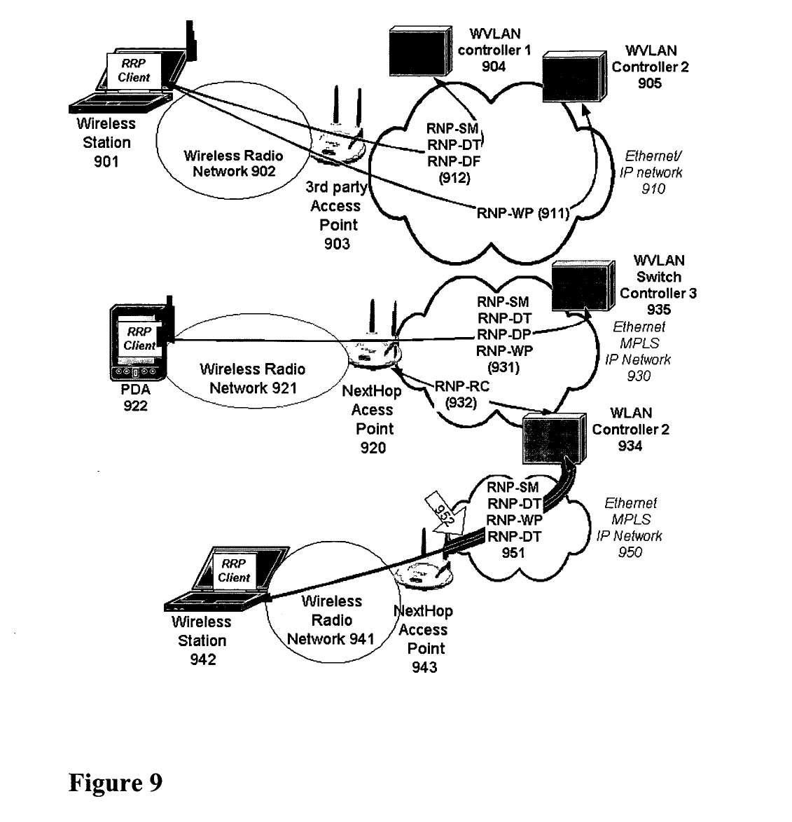

FIG. 9 shows how a virtual client can run on a PC (901) on a wireless network (902) and communicate across a 3rd part access point (903) that does not support the RNP protocol. The RNP protocol is created on the virtual client on the PC (901) and ships the RNP sub-protocol streams to two different controllers WVLAN controller 1 (904), and the WVLAN controller 2 (905).

FIG. 9 also shows how a PDA can run the virtual software. In FIG. 9, the tunnel exists across a wireless network (921) to a LWAP point with this invention. The virtual client passes RNP sub-protocol streams (931) to the WVLAN controller 3 (935). A third option for the use of these virtual clients is illustrated in FIG. 3 wherein the connection of the virtual client on the PC (942) connects to a LWAP point (941) across a wireless network (943), and joins a tunnel (952) passing RNP sub-protocol messages (951) to WVLAN controller 2 (934).

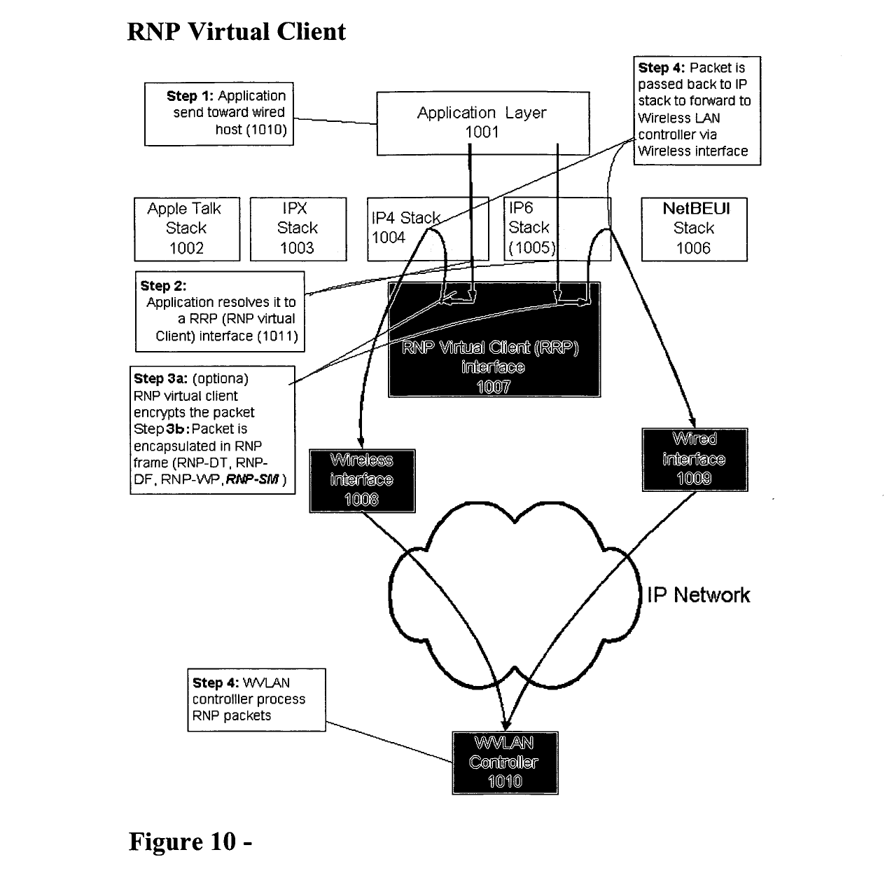

FIG. 10 shows the steps that may be taken in encapsulating this data:
Step 1—Application data is sent toward a wired host in the enterprise (1001),
Step 2—Application resolves it to an RNP virtual client via IPv4 stack (1004) to RRP 1007, or via IPv6 stack (1005) to RRP 1007,
Step 3
   a) Client encrypts the packet. As non-limiting examples, the encryption may be performed using 802.11i, WPA, WPA2, RC4 or other encryption algorithms.
   b) client sends via the RNP protocol (RNP-DT, RNP-DF, RNP-WP, RNP-SM) to the controller over a UDP/IPv4 tunnel or a UDP/IPv6 tunnel.
Step 4—The remote WVLAN controller 4 processes the RNP packets as other packets.
   Utilization of Layer 2 Encryption Instead of IP-Sec Tunnels to Secure Data

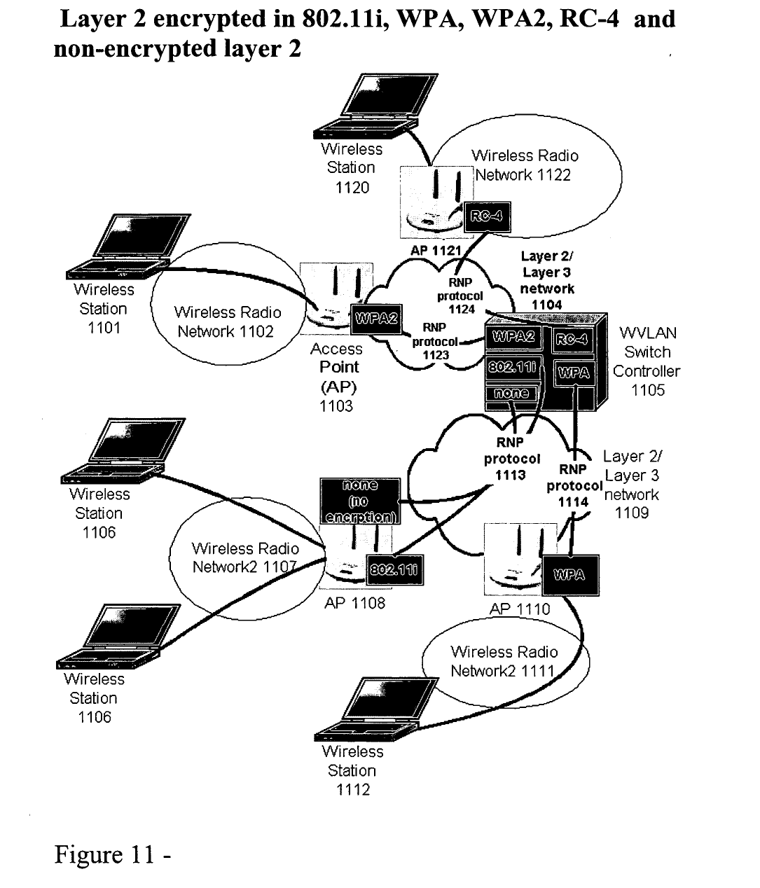

Embodiments of this invention use layer 2 encryption protocols, such as 802.11i instead of IP layer secure tunnels (such as IP-Sec) to secure wireless data. FIG. 11 illustrates an example of a network in which different access points are encrypted with different layer 2 encryptions such as, by way of non-limiting example, 802.11i, WPA, WPA, RCA4. Embodiments allow each of these access points (1103, 1108, 1110, 1121) to:
encrypt a wireless stations traffic with an encryption,
pass the traffic to the remote WVLAN controller via the RNP protocol (1113, 1114), and,
decrypt the traffic on the WVLAN controller (1105).

Such embodiments protect the user data between the lightweight access point and the layer2/layer switch without using an IP layer secure protocol (such as IP-Sec).

As FIG. 11 shows, this encrypted data can run in parallel with the non-encrypted data (AP 1108) in the RNP protocol.

Embodiments of this invention terminate the encryption of the data on a wireless LAN switch. Other embodiments of this invention terminate the encryption of the data on a Switch/Router. Yet another embodiment of this invention terminates the encryption on another Access Point.

Discovery/Imprinting Used by Access Points to Locate Controllers

Embodiments of this invention has a method for a NextHop WiFi AP to be “imprinted” with information from a Wireless Controller/Switch by implementing a mechanism known as “Imprinting”. In embodiments of the invention, “Imprinting” includes one or more of the following steps:
1. The WiFi AP and the Wireless Controller/Switch discover each other over a Layer 2 network using a broadcast RNP-RC (Radio Control) message. The RC-Name-Request message is used for this purpose.
2. Optional approval by administrator or policy that allows the AP to be controlled by the Wireless Controller,
3. The AP storing the discovered addressing information for the controller (e.g. DNS name, IP Address) in its persistent memory e.g. Flash memory
4. Use of persistent information stored in the AP to establish future sessions with the Controller. The future sessions may be established after moving the AP to a new location. The new location may have a Layer 3/IP network between the AP and the controller.
5. Optional augmentation of primary controller addressing information with a secondary controller addressing information, to be used when the primary controller is unavailable. The secondary information is communicated via RNP-RC protocol and is stored in the AP persistent memory.

If the AP cannot communicate with its controller via a Layer 2 (Ethernet) broadcast, the DNS name or IP address of the controller is provisioned on the AP via a local interface (e.g. serial interface).

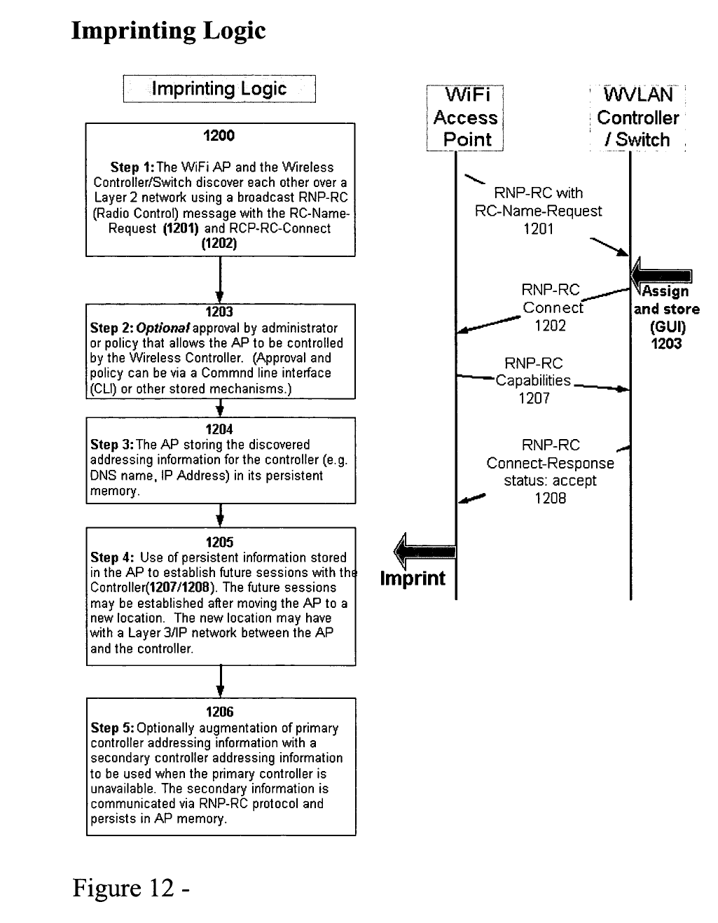

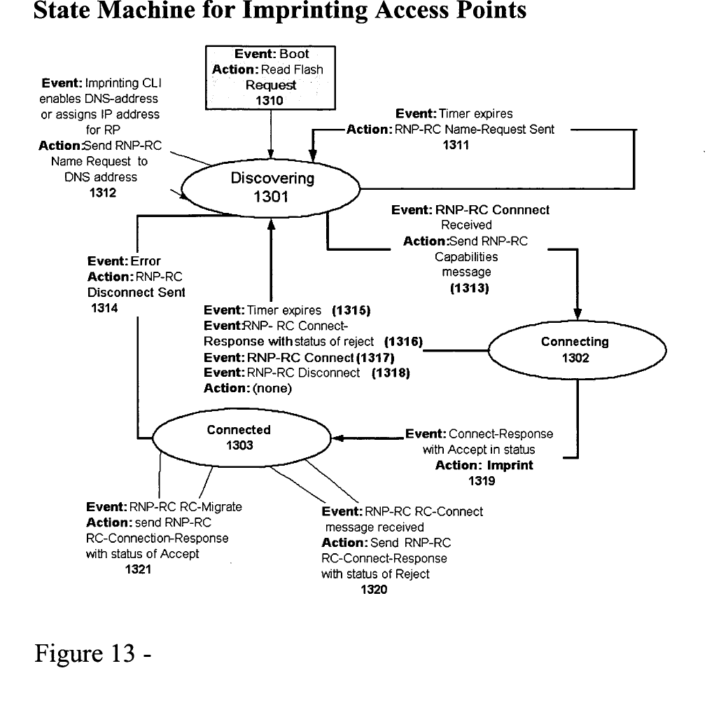

One embodiment of this method is shown in FIG. 12 aligned with the RNP messages. Steps 1-5 are listed as items (1200, 1203, 1204, 1205, 1206) respectively in this Figure. For this embodiment of this method, FIG. 13 provides the state machine for the Access Point in sending RNP-RC messages. In this state machine there are three states: Discovering (1301), Connecting (1302), and Connected (1303).

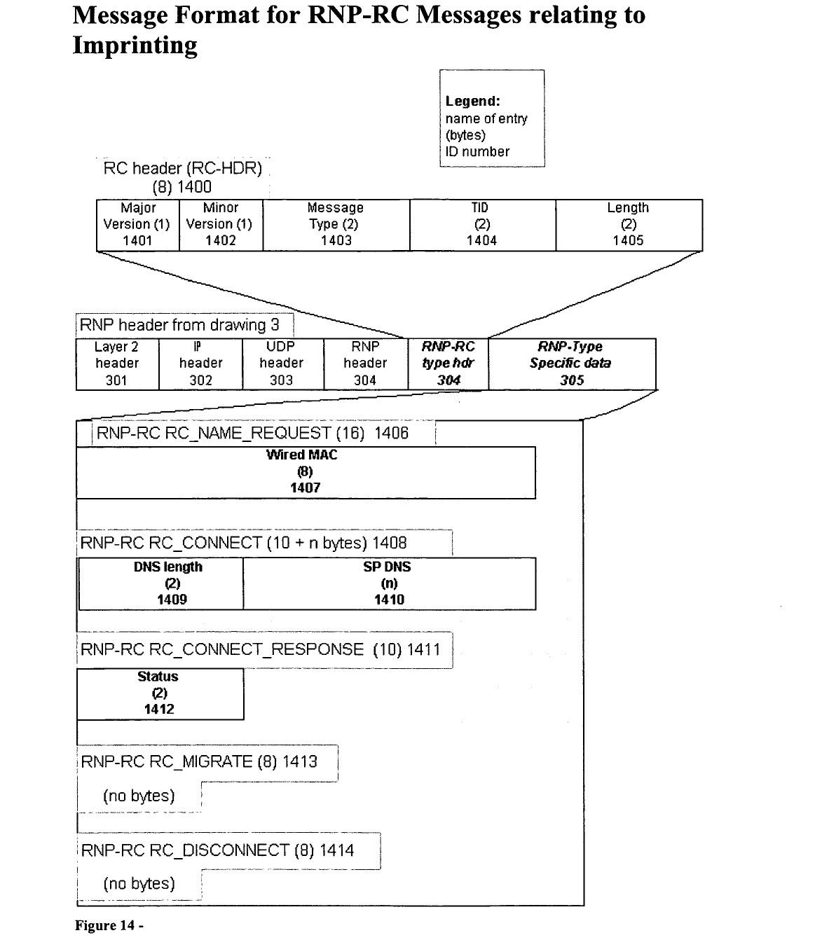

FIG. 14 illustrates an example message format for the RNP-RC messages for imprinting. The RNP-RC messages have the RNP common header (304), followed by an RC specific header (1400), followed by a RNP-RC type specific format. The RNP-RC header has the fields for: major version (1401), minor version (1402), primitive (1403), Transaction ID (TID) (1404), length (1405). The RNP-RC messages for imprinting include:
RNP-RC_MSG_NAME_REQUEST_MESSAGE (message body 1406-1407)
RNP-RC_MSG_CONNECT (message body description is 1408-1410)
RNP-RC_MSG_ACCEPT (message body description 1411-1412),
RNP-RC_MSG_MIGRATE (message body description 1413)
RNP-RC_MSG_DISCONNECT (message body description 1414)

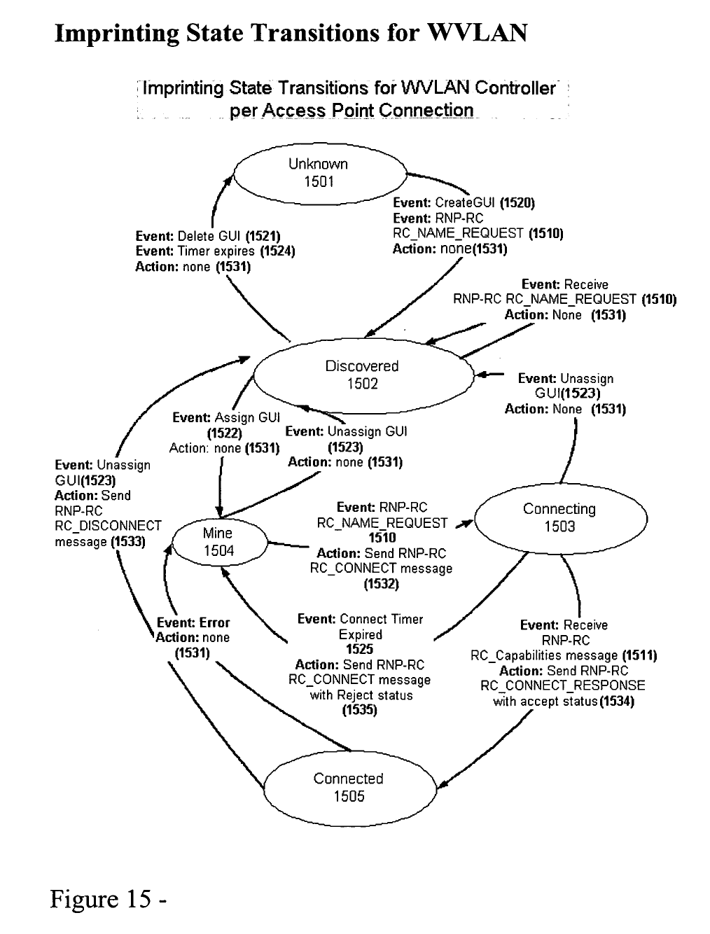

FIG. 15 shows an embodiment of this method in a state machine for the WVLAN controller supporting an imprinting. This state machine has 5 states: Unknown (1501), Discovered (1502), Connecting (1503), Mine (1504), Connected (1505). In embodiments of the invention, the state transitions between these states are caused by the following events:
User interface changes: GUI creation (1520), GUI delete (1521), GUI assignment (1522), GUI un-assignment (1523),
Timer expirations: discover timer (1524), connect timer (1525), and
RNP-RC messages received: RNP-RC_MSG_NAME_REQUEST (1510), RNP-RC_MSGCAPABILITIES (1511).

Each event may or may not have an action associated with it.

Virtual LAN (VLAN) Assignment and Separation of Virtual LANs (VLANs) Over Air Using Different Encryption Keys

The 802.11 standard does not define a mechanism to assign VLANs to 802.11 data traffic over the air. Typically, an Extended Service Set ESS is mapped to a single VLAN. An ESS, and thus VLAN, typically implements a single type of security protection for the 802.11 data traffic.

Embodiments of the invention allow multiple VLANs to be advertised and their traffic segregated over the air. In embodiments, this is accomplished by allowing multiple security types to be associated with each ESS, each of which is assigned a VLAN. In embodiments, if no VLAN is associated with an ESS security type, then the VLAN assigned is determined by the default VLAN configured for the ethernet interface on the AP. In addition, a policy-based VLAN (RFC 3580) may be assigned by a AAA server or a Directory server on a per-user (client station) basis. One restriction on the security types chosen for an ESS is that either all or none of them must provide over the air encryption.

Embodiments of the invention include security models as well as methods of encrypting traffic using such security models.

In embodiments, a security key is associated with each virtual interface denoted by a tuple, including the tuple denoted <VLAN, BSSID, Security Type> where “BSSID” denotes the Wireless MAC address of the (potentially virtual) AP which is advertising the ESS, “VLAN” denotes a supported VLAN (either via assignment to Security Type as default, policy or governed by network topology), and “Security Type” is one of the security types supported by the Wireless Network. The security types that may be supported include:
802.11 Open Authentication with no encryption,
802.11 Open Authentication with static WEP key, 802.1X with dynamic WEP encryption, WPA (TKIP), WPA2 and 802.11i (AES),
802.11 Shared Authentication with static WEP key

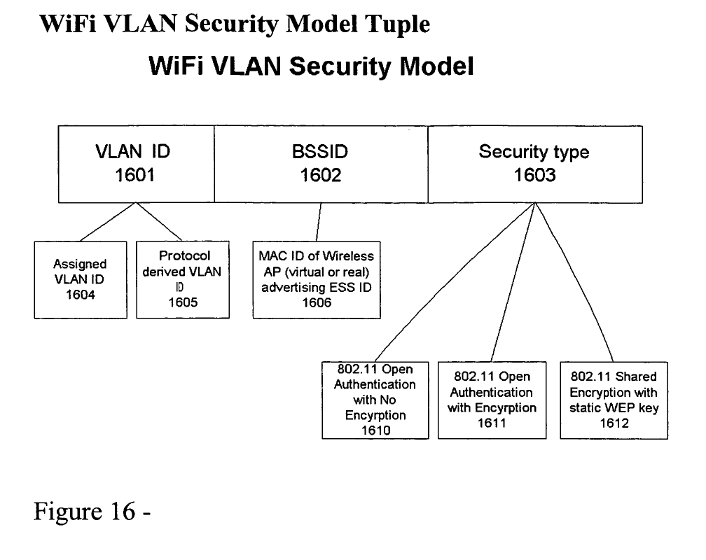

FIG. 16 illustrates the security model with its security key of the tuple <VLAN,BBSID, Security type> and the security types of: 802.11 Open Authentication with no encryption (1610), 802.11 Open Authentication (1611), and 802.11 Shared Authentication (1612).

In embodiments, all broadcast traffic over the air is encrypted with the security key for the virtual interface. All unicast traffic over the air is protected by the pair-wise key negotiated for the security type between the AP and the client. This mechanism supports multiple VLANs over the air for associations via a single (potentially virtual) AP (with a unique BSSID) and achieves the desired VLAN data traffic separation over the air preserving VLAN semantics.

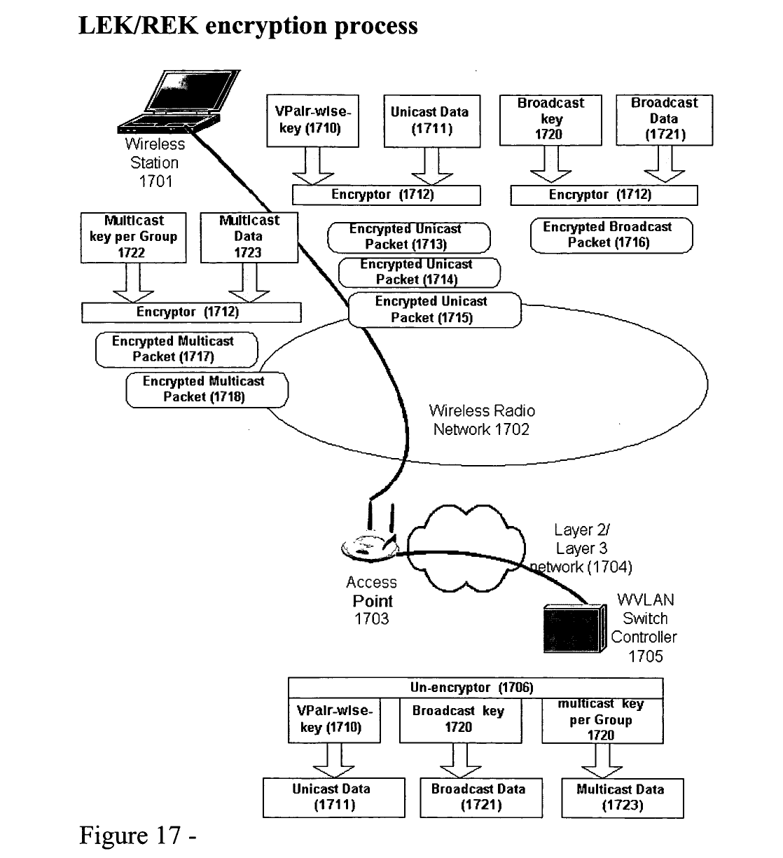

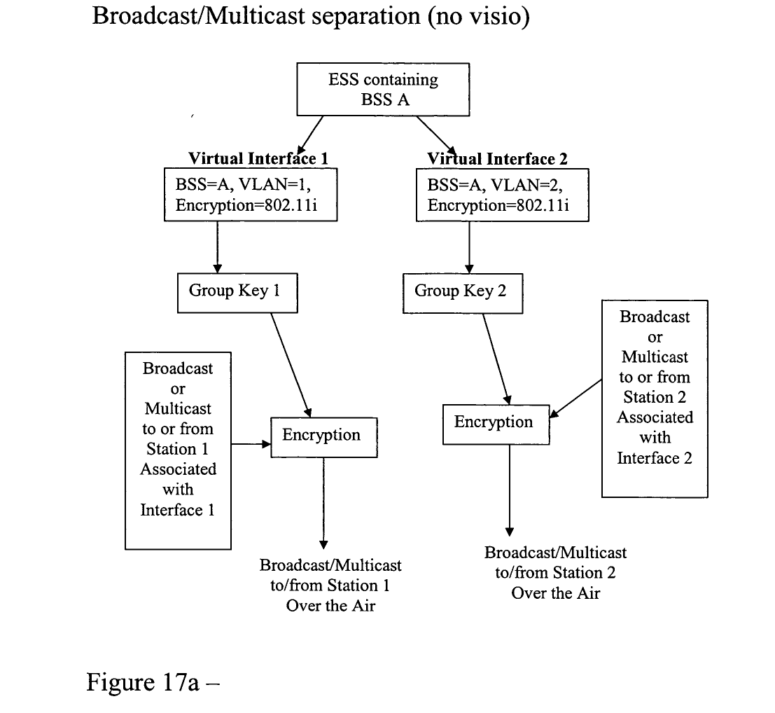

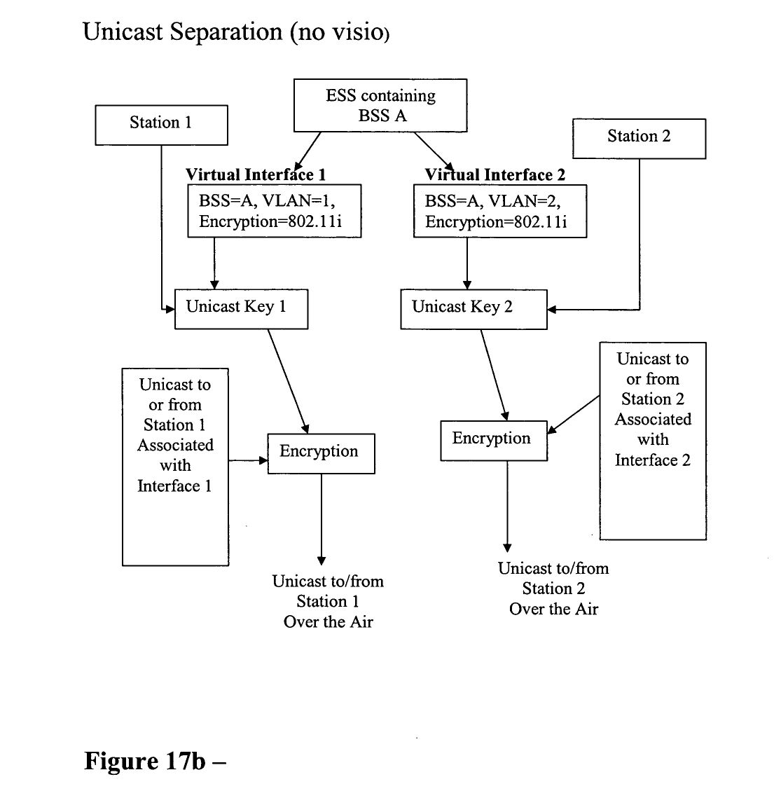

FIG. 17 illustrates the encryption of the broadcast, multicast and unicast traffic between a wireless station (1701) and an AP (1703). The traffic flows from the wireless station across the wireless network (1702) to the AP (1703) to the wireless controller (1705). The unicast traffic (1711) is encrypted with the pair-wise key (1710) negotiated between the AP and the client and sent in unicast packets (1713, 1714, 1715) to the AP. The broadcast data traffic (1721) is encrypted with the broadcast key for the virtual interface (1720) and sent as packets (1716) across the wireless network(l702). The multicast data (1723) is encrypted with a per group key (1722) and sent across the wireless network (1702). Decryption of the packets occurs on the AP (1703) or the Wireless controller (1705). The un-encryption (decryption) of the packets is based on the type of packet as determined from the packet Layer 2 addressing information. The un-encryption (1706) uses the appropriate key per type of data: Unicast pair-wise key (1710), Broadcast key (1720), and Multicast (1722).

Routing Intelligence in a WiFi Client when an Enterprise is terminated on WLAN controller and Local Traffic is Terminated at the AP

The embodiment of the RNP in the WiFi VPN client is sometimes referred to by the acronym “RRP”. RRP is synonymous with the use of the RNP in the WiFi VPN virtual client.

In embodiments, an RRP client allows 802.11/802.11i based security to be applied to providing a wide-area VPN without use additional infrastructure such as IPSec or PPTP. When the RRP client is remotely connected to the Wireless LAN Controller/Switch over a Layer-3 network. One application of such a topology is to a branch office wireless network.

In a branch-office scenario, both traffic destined to local network (e.g. a local printer) and to the remote corporate office share the same 802.11 (802.11i) based authentication mechanism and policy controlled by the corporate office. In order to segregate and properly protect the data traffic, the RRP client provides a routing finction that works as follows:
1. One or more local encryption keys (LEKs) and one or more remote encryption keys (REKs) are derived from the authentication process. Without limitation, multiple LEKs and REKs may be derived each for a combination of local or remote destination and traffic type (Unicast, Broadcast, and Multicast).
   In embodiments, Unicast LEK or REK derivation involves the use of one-way hash function over the 802.11i derived PTK (Pairwise Transient Key)
   In embodiments, Broadcast LEK or REK derivation involves use of Unicast LEK or REK to encrypt a random key and passing that key to the client.
   In embodiments, multicast LEK or REK derivation involves the use of Multicast LEK or REK per group to encrypt a random key and passing it to the client. The multicast REK is used to encrypt multicast traffic destined for a group.
2. Traffic is segregated into two portions: Traffic that will be sent to the local network and traffic that is destined for a remote network.
3. All the traffic that is destined to the local network (subnet, vlan etc) uses a local encryption key (LEK) is available to local AP (Access Point).
4. All the traffic that is destined to the remote network (subnet ,vlan etc) uses a remote encryption key (REK) that is not available to the local AP but is available to the WVLAN Switch or Controller at the remote destination.

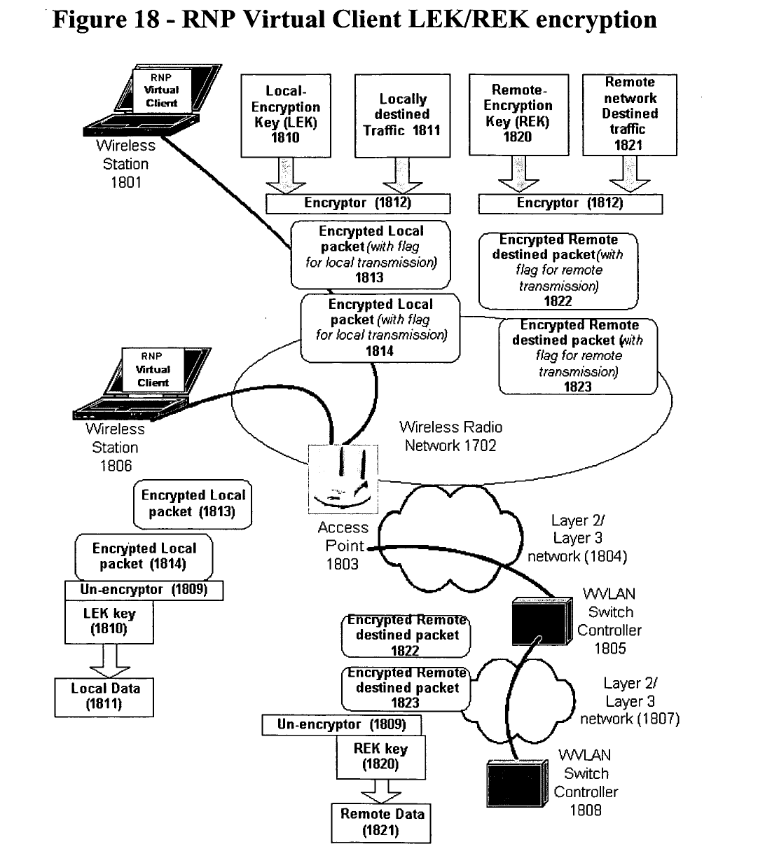

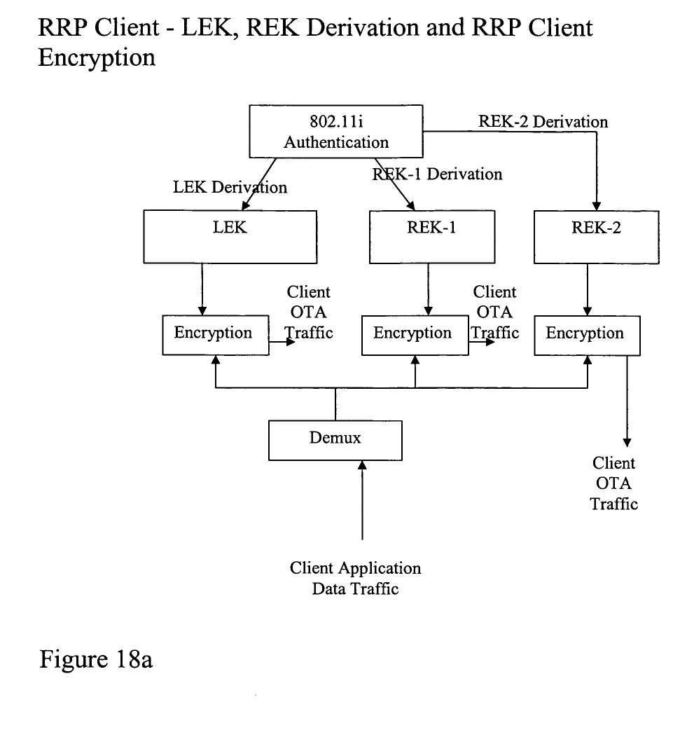

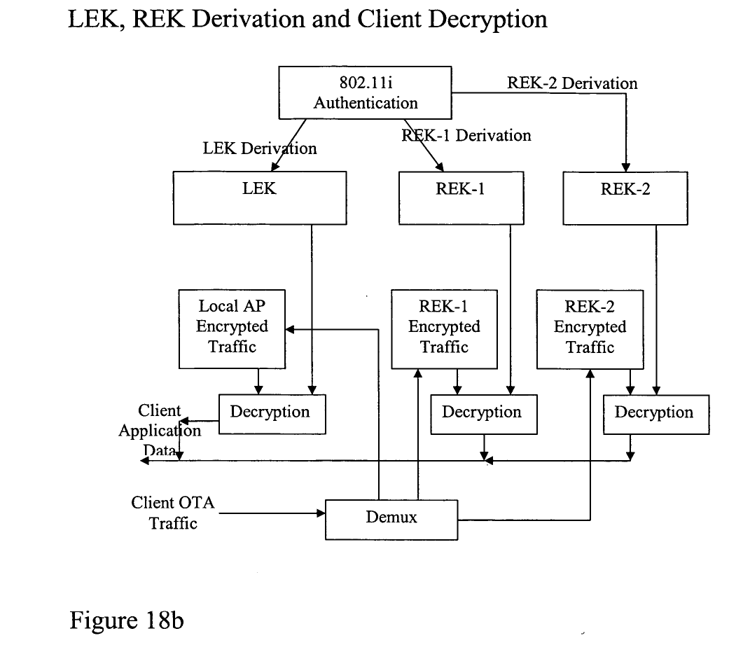

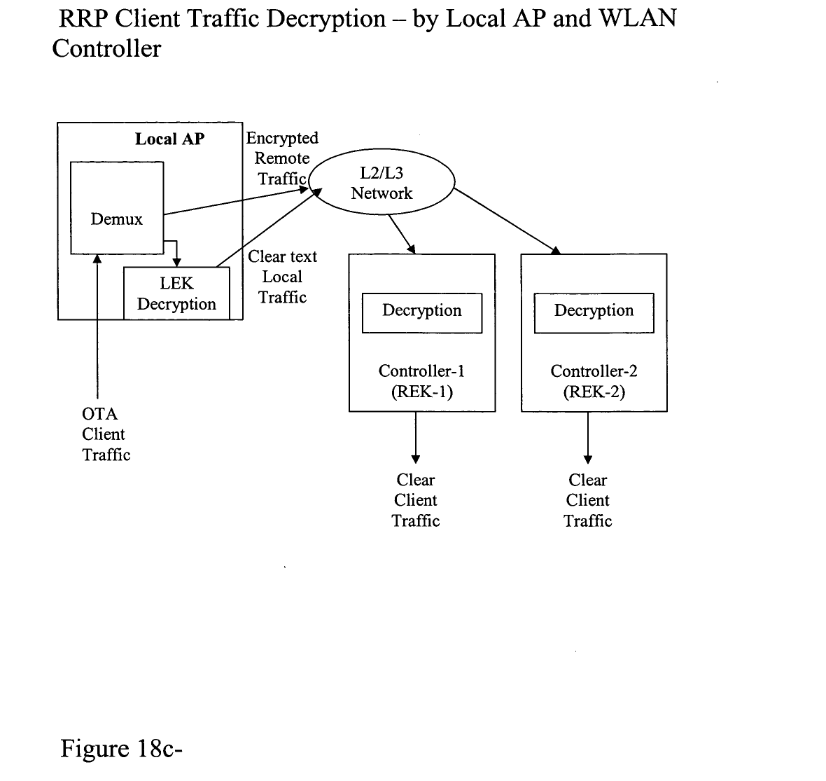

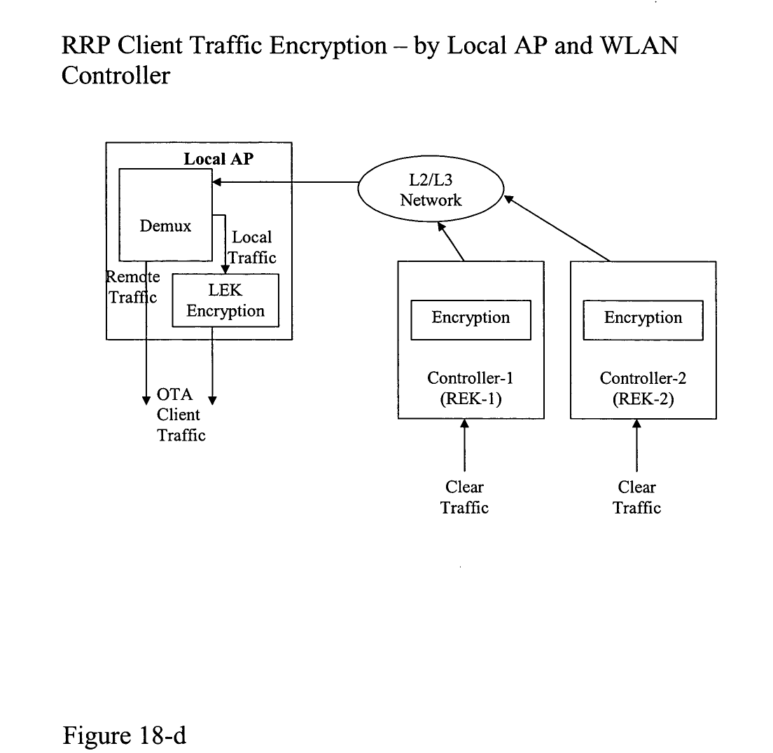

FIG. 18 shows one embodiment of this invention to encrypt local traffic and remote traffic with different keys (LEK, REK). The virtual client running on wireless station (1801) encrypts the locally destined data (1811) with a local encryption key (1810) and sends the data in packets flagged with the “locally” transmitted data (1813 and 1814). The local virtual client (1806) puts the packets (1813 and 1814) through a un-encryptor (1809) with the local key (1810) to decrypt the data. The remote client on WVLAN controller 2 (1808) receives the packets (1822, 1823) across one wireless network (1802), and several wired networks (1804, 1807). Using an un-encryptor (1809) and the REK (1820), the data is unencrypted to restore the original data (1821).

This mechanism allows traffic destined to the remote network to be encrypted without additional overhead or VPN to be implemented on the AP. The AP may disambiguate between traffic destined to the local network from the remote network using a special bit in the 802.11 frame fields (e.g. frame control, a special reserved mac address such as address 4 in the frame).

FIG. 18 also shows this branch office scenario topology that utilizes the “Routing Intelligence” that keys on the special portion of the 802.11 frame and encrypts the local traffic using a LEK and remote traffic using an REK.

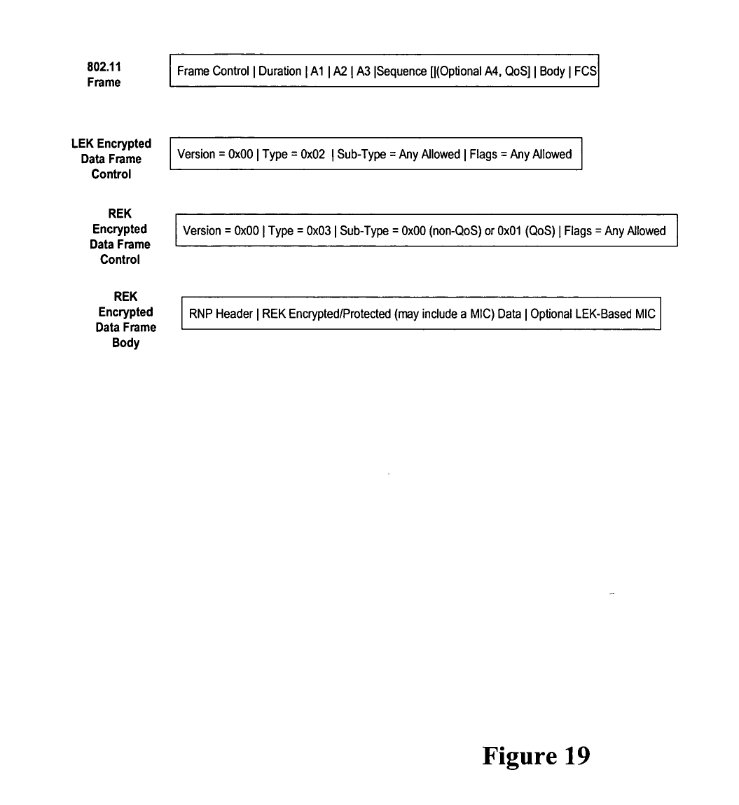

FIG. 18a shows a client uses LEK/REK to encrypt data. FIG. 18b shows how a client users LEK/REK to decrypt data. FIG. 18c shows how local traffic may be passed unencrypted and remote traffic passed encrypted, FIG. 18d shows remote encrypted traffic is demuxed from local traffic. Local traffic in FIG. 18d is also encrypted prior to forwarding it. FIG. 19 shows the special Frame control field and a special MAC address for unicast traffic.

For example, the currently unused 802.11 frame control field values may be used to denote that the frame is encrypted using a REK and that it will be decrypted at the destination. The local AP will simply bridge this frame to the wired network. In order to avoid the potential denial of service attack, an optional special message integrity checksum using LEK may be used or this type of bridging is restricted to RNP protocol PDUs to known destinations.

WiFi VPN in Wireless Mesh Networks

This invention includes methods to support the bridging of 802.11 frames via RNP over Wireless (802.11) network infrastructure until the point where it enters (1) the wired network or a wireless LAN switch or an access controller or (2) another device in the network that has the security state to decrypt the client traffic. This approach avoids hop-by-hop encryption that is specified by the current wireless standards and practice when applied to mesh-based wireless networks.

In an embodiment of this invention, 802.11 frames from a wireless client station enter a RF/Wireless Mesh-based distribution system at an AP and are bridged and routed to the integration service portal via RF interfaces on other APs in the mesh. The system does not terminate 802.11i or other encryption on the AP where the station traffic enters the RF mesh, but does so at the point where it enters the wired network.

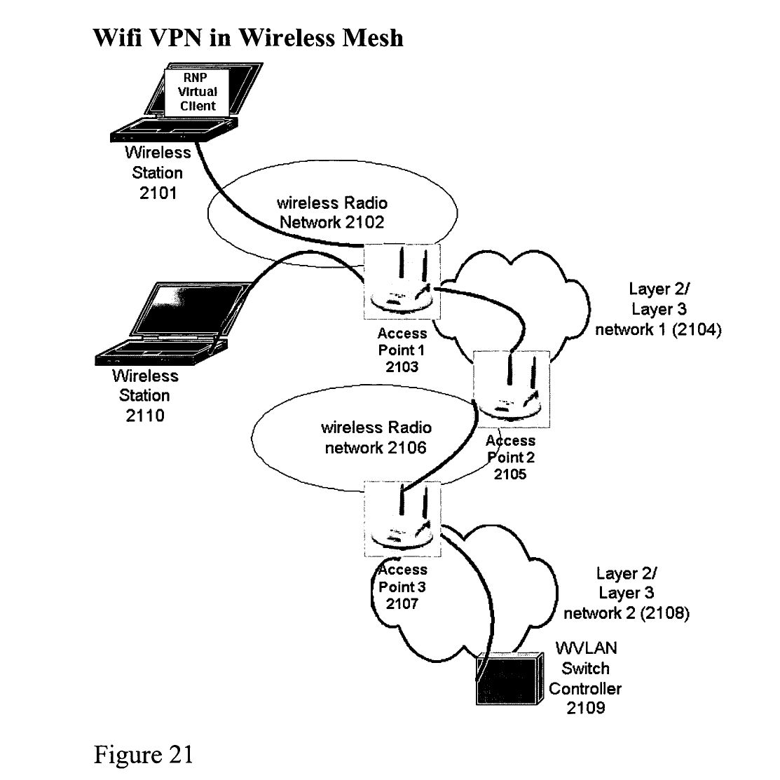

FIG. 21 shows one embodiment of this invention. The packets from wireless client (2110) are transmitted are encrypted at access point 1 (2103) and transmitted via RNP to the wireless controller (2109). The pathway from AP-1 to the wireless controller is:
via AP-1 (2103) across the wired network 1 (2104) to AP-2 (2105),
from AP-2 (2105) across the wireless network (2106) to the AP-3 (2107), and
from AP-3 (2107) across the wired network (2108) to the wireless controller (2108).
   Methods for Pairwise Master Key (PMK) Sharing

The Wireless LAN Switch or Controller architecture provides an 802.11i authenticator component that obtains the PMK based on current standards. This PMK is known only to the authenticator for the current client association between a client and a authentication server. However, if the switch contains an authenticator component for more than one AP, the PMK may be shared among the APs (or 802.11 BSSes) without violating security guarantees. In the context of this invention, the PMK for a given client and the authentication server used by each authenticator may be:
Identical
derived from another PMK for the same client and authentication server, or
combination using implicit or publicly observable information using a one-way cryptographic hash function such as a HMAC-SHA1.

This method may be used to avoid the superfluous (re-) authentication to the network while re-associating or roaming to another AP within an ESS or within an authentication domain. One way for the wireless client and the AP to use the above mechanism is to advertise the capability to perform PMK sharing and fast roaming as described here. Such advertisement could use additional 802.11information elements or additional components (bits) in the capabilities in standard 802.11informational elements such as 802.11i RSN an information element.

Sharing, such as above, is also possible when roaming between multiple WLAN switches or controllers. It is also possible to share a PMK between a Wireless LAN switch or controller and a traditional fat AP or between fat APs themselves. In one mechanism of sharing, an authenticator for an AP obtains roaming authorization tokens from the authentication server for the APs in its RF neighborhood when the wireless client first authenticates to the network.

The authenticator may pass the BSSIDs in the Wireless network for the RF neighborhood of the station associating to the authentication server using RADIUS messages. These messages could be the same ones as that which are being used to transport EAP messages from the client.

In order to facilitate enterprise policy enforcement, the authenticator may communicate ESS identification (e.g. SSID) and security mechanism (e.g. 802.11i) being requested by the client station for the association to the authentication server. One mechanism for doing this is to use (potentially new or vendor-specific) RADIUS attributes with this information in the case where AAA service is provided by a RADIUS server.

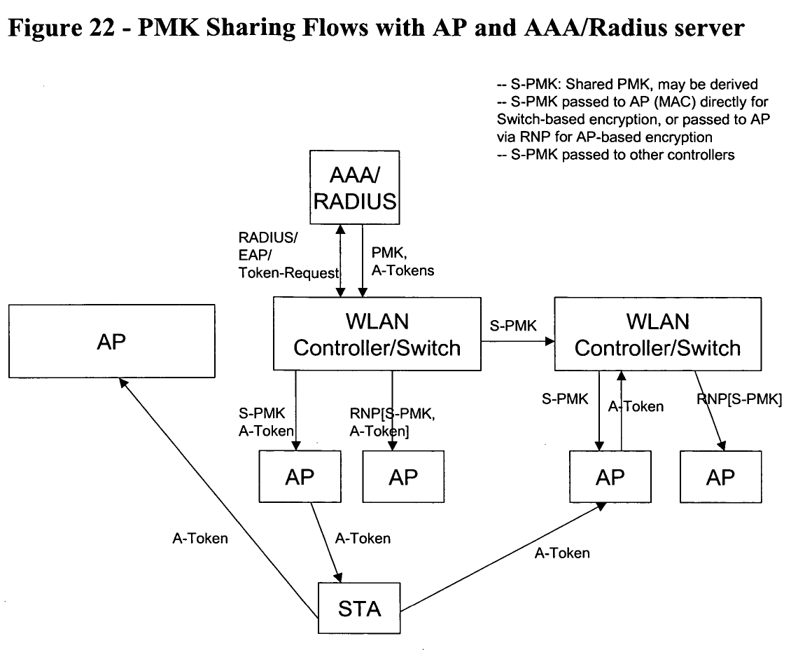

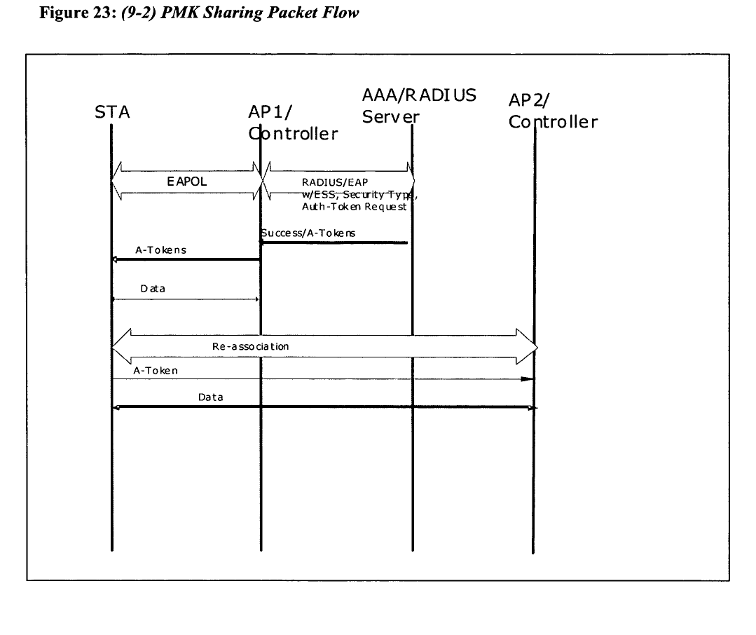

FIG. 22 show an embodiment of this logical interaction of the PMK tokens with the Radius AAA service. FIG. 23 shows a normal packet flows for PMK tokens using the Radius EAP packets.

Using the ESS, BSS and Security information in the request, the authentication server (e.g. RADIUS) may generate and return to authenticator the appropriate authorization tokens. In the case of RADIUS based AAA, the tokens may be returned in the Radius-Accept message used to indicate the success of the client authentication

In another mechanism of sharing, the PMK authorization tokens are generated for APs in the RF neighborhood using public key encryption—by encrypting the PMK or material derived from PMK using the target AP public key—if the Access Points (APs) share public keys or public key certificates or part of a public key infrastructure.

In some embodiments, the authorization tokens may be transmitted on a public network or over the air and can only be decrypted by the corresponding AP to obtain the PMK using a shared secret between the AP and the authentication server or the receiving Access Points (APs) own private key when using the public key mechanism. The superfluous re-authentication process and its resultant latency in a roam are thus avoided.

One mechanism of this invention for transferring the PMK or authorization tokens is using the wireless client to transfer the PMK. The tokens may be distributed to the client gratuitously (for example, using a to-be-defined 802.11 management frame or 802.1x frames) or upon request from the client. The client transfers these tokens to the target AP as part of or prior to the 802.11 re-association procedure. This mechanism preserves the security trust binding of a PMK between the authenticator, the wireless client and the authentication server.

Another mechanism for transferring the PMK or authorization tokens is to use a RNP or other protocol frame addressed to the target AP.

Yet another mechanism for transferring authorization tokens is to provide these tokens securely encapsulated or encrypted in the standard EAP mechanisms used for authentication (e.g. 802.11i). An authorization token for to which the wireless client is currently associated may optionally be passed using this mechanism validating the 3-way trust binding between the client, authenticator and the AAA server.

Remote Network Protocol (RNP)

Embodiments of this invention includes methods for encoding PDUs in the Remote Network Protocol (RNP) packets, as well as the packet exchanges and state machines for handling such packet exchanges

Such embodiments support multiple sub-protocols by using a “type” field in the RNP protocol. This method allows the number of sub-protocols to be extensible to large numbers of sub-protocols.

Embodiments also allow sub-protocols to further sub-divide into to sub-streams. An embodiment of this invention uses the “primitive” field in the sub-protocol headers to split the sub-protocols.

Enterprise Authentication Over Shared-WISP Infrastructure

In the prior art, when WiFi VPN is deployed at a hotspot, a wireless client connecting to the enterprise is authenticated twice—once by the hotspot provider and once by the authentication server at the enterprise. Embodiments of the invention allow enterprise authentication to be used by the hotspot provider, rather than a separate authentication. This allows an enterprise to share the WISP infrastructure, using, by way of non-limiting example, a subscription based business model, while maintaining control of enterprise access. Some such embodiments also utilize a single authentication for a given client access. Such embodiments also allow two different clients associating with the same WISP AP to be authenticated at different enterprises.

In embodiments of this invention, when the WiFi VPN is deployed at a hotspot with a lightweight access point, a late/lazy binding from the client to the wireless LAN Controller/Switch can be made by the WISP AP intercepting the EAPOL start message sent by the client, and returning a EAPOL request identity message. The WISP AP may also send an EAPOL request identity message to the client gratuitously without waiting for the EAPOL start message.

The wireless client may respond to the request identity message with a EAPOL response identity message which includes a cleartext field with the client's domain name. As non-limiting examples, this domain name can be (1) a DNS name, (2) the name of the client's enterprise that can be looked up against a DNS server or (3) a directory (e.g. LDAP) server to obtain the IP address or DNS address of the wireless LAN Controller/Switch to which the client will connect.

Following the initial exchange, further EAPOL messages are tunneled to the WLAN Controller/Switch using the WiFi VPN (RNP) encapsulation protocol. The authentication is done by the enterprise authentication server that terminates the EAP protocol within the enterprise. The WISP AP is directed to allow data traffic flow only if the wireless client is successfully authenticated via the RNP protocol.

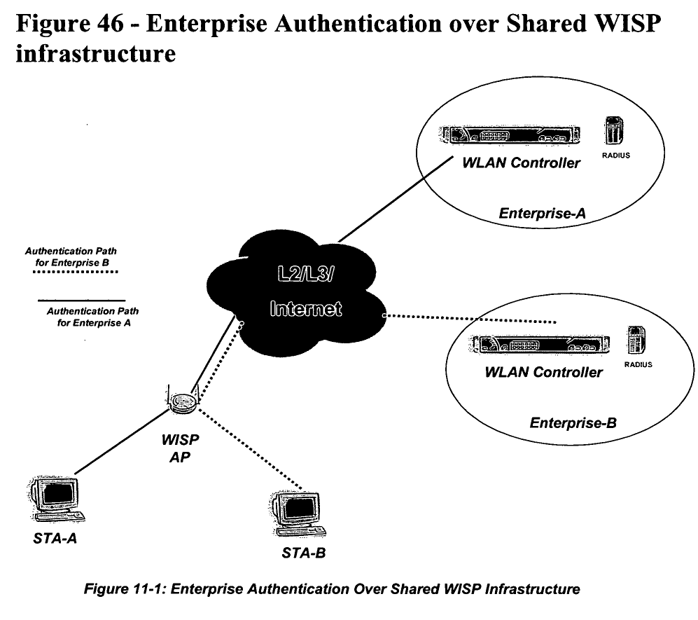

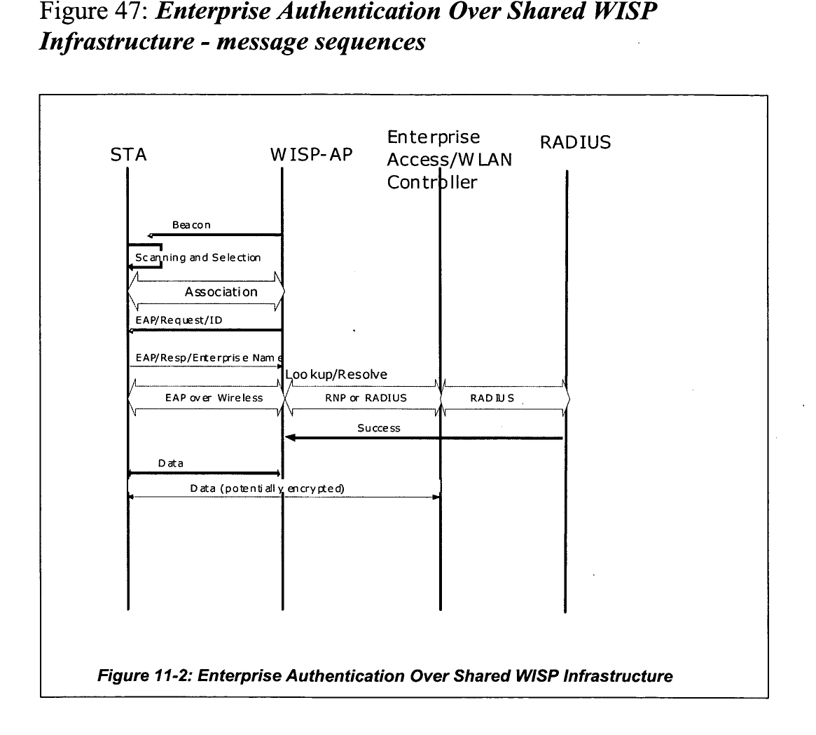

FIG. 46 shows the network topology applicable to this invention. FIG. 47 illustrates the packet flow for the authentication process.

Optionally the WISP AP may forward all client data traffic to their respective enterprise WLAN Switch/Controller.

Remote Network Protocol (RNP)

In embodiments of the invention, the RNP protocol runs over the UDP/IP protocol and supports multiple sub-protocols. In one embodiment shown FIG. 3 there are 5 sub-protocols:
RNP-Radio Control (RNP-RC)—items 311 and 312 in FIG. 3,
RNP-Station Management (RNP-SM)—item 313 and 314 in FIG. 3,
RNP-Data Transfer (RNP-DT)—item 315 and 316 in FIG. 3,
RNP-Web Portal (RNP-WP) )—item 317 and 318 in FIG. 3, and
RNP-Data Forwarding (RNP-DF)—item 319 and 320 in FIG. 3.

The RNP protocol is extensible to any number of sub-protocols via the RNP header methods that specify the type field (FIG. 7 item 704). As FIG. 3 shows, the information following the RNP common header (FIG. 3 item 304) is the RNP sub-protocol specific header (FIG. 3 item 305), followed by the RNP sub-protocol specific data.

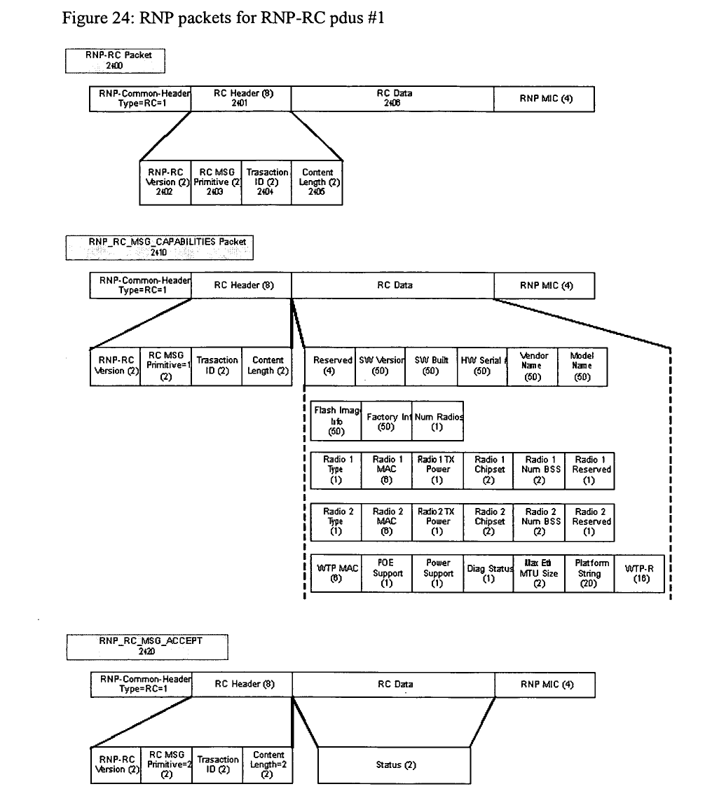

The sub-protocol header for the RNP-RC sub-protocol contains the following information as shown in FIG. 24:
RNP-RC-version (2 bytes)—the version of the RNP-RC sub-protocol (item 2402)
Primitive type—the type of action primitives used to operate the RNP-RC functions (item 2403)
Transaction identifier—If a transaction is initiated by the wireless controller, this field will contain an ID. Responses from the Access Point will contain this identifier to match requests with responses (item 2404)
Content Length—Length of the Message Content (item 2405)
Content—RNP-RC sub-protocol specific data (item 2406)

The RNP-RC protocol method further defines the primitives as the table below. (For the table below, Access Point is abbreviated as AP and Wireless Controller Service Point is abbreviated as SP.

RNP-RC Primitives

| Primitive Name | Value | Sender | Primitive Use |
|---|---|---|---|
| RNP_RC_MSG_CAPABILITIES | 1 | AP | Sent by the AP to identify itself to the SP when it first |
| | | | connects to the SP |
| RNP_RC_MSG_ACCEPT | 2 | SP | Sent by the SP to accept or reject an AP |
| RNP_RC_MSG_CONFIGURE | 3 | SP | Sent by SP to set initial configuration in the AP |
| | | | Contains configuration information for the AP |
| RNP_RC_MSG_CONF_RESP | 4 | AP | Sent by AP in response to an |
| | | | RNP_RC_MSG_CONFIGURE message. |
| RNP_RC_MSG_MO_SET | 5 | SP | Sent by SP to set values for a list of Managed Objects |
| RNP_RC_MSG_MO_SET_RESP | 6 | AP | Sent by AP in response to an RNP_RC_MSG_MO_SET |
| | | | message. |
| | | | Contains status for set of each object. |
| RNP_RC_MSG_MO_GET | 7 | SP | Sent by SP to read values for a list of Managed Objects |
| RNP_RC_MSG_MO_GET_RESP | 8 | AP | Sent by AP in response to a RNP_RC_MSG_MO_GET |
| | | | message. |
| | | | Contains list of Managed Objects. |
| RNP_RC_MSG_TRAP | 9 | AP | Sent by AP to notify SP about exceptions in the AP |
| RNP_RC_MSG_MEASUREMENT | 10 | AP | Sent by AP to deliver measurements to the SP. |
| | | | Periodicity and content of measurements are defined by |
| | | | MO measurement settings. |
| RNP_RC_MSG_NAME_REQUEST | 11 | AP | Sent by AP to request the DNS name of the SP. |
| RNP_RC_MSG_CONNECT | 12 | SP | Sent by the SP in response to a NAME_REQUEST. |
| RNP_RC_MSG_LOG | 13 | AP | Sent by AP to place an AP log entry into the SP's event |
| | | | log. |

A key benefit of this RNP-RC sub-protocol is the discovery, configuration and management of options (managed wireless station options) names and request.

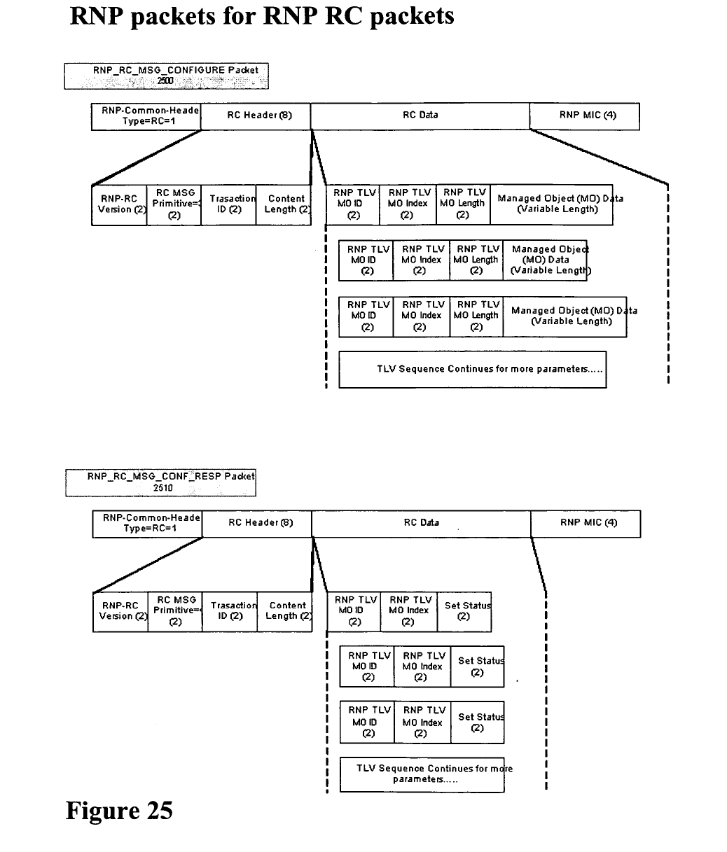

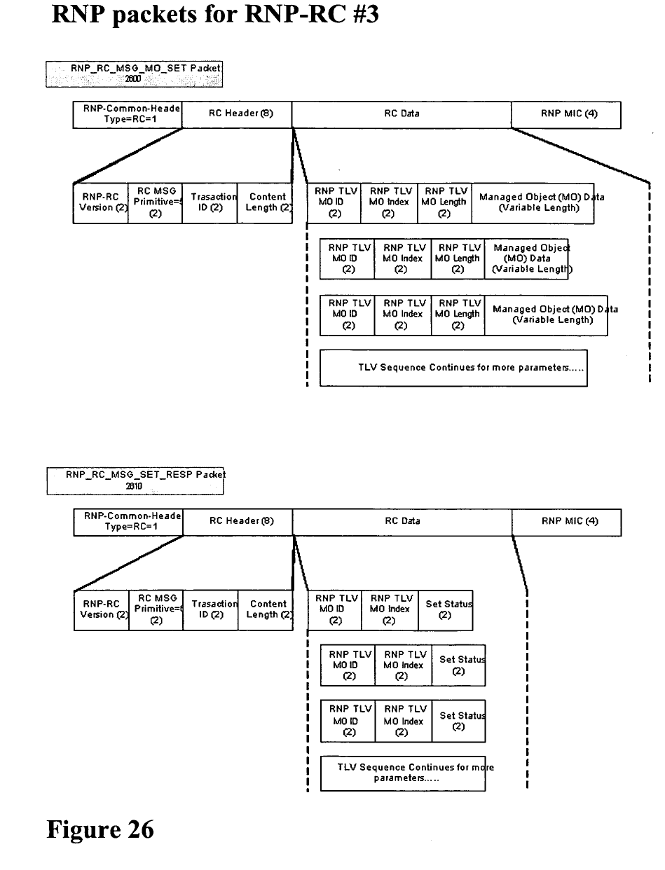

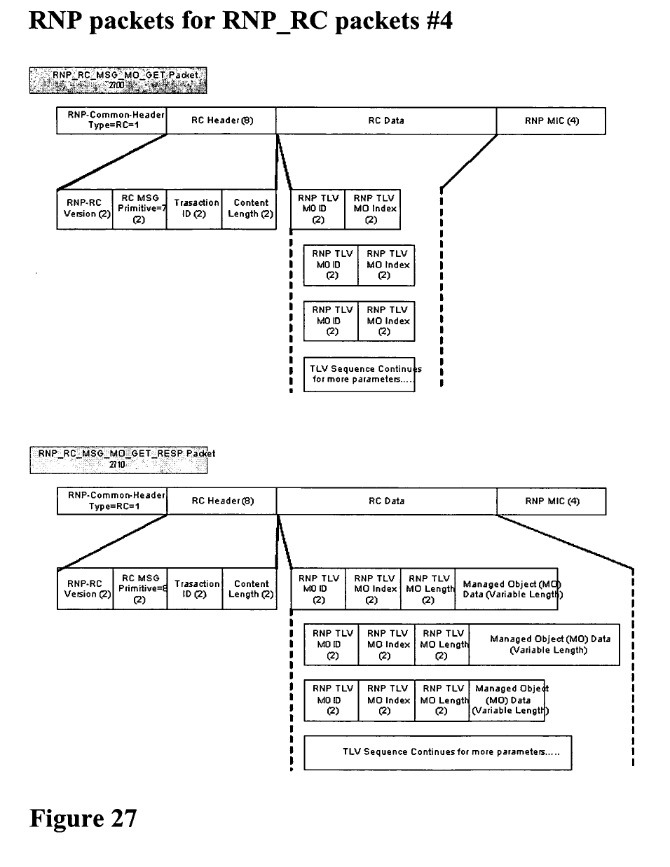

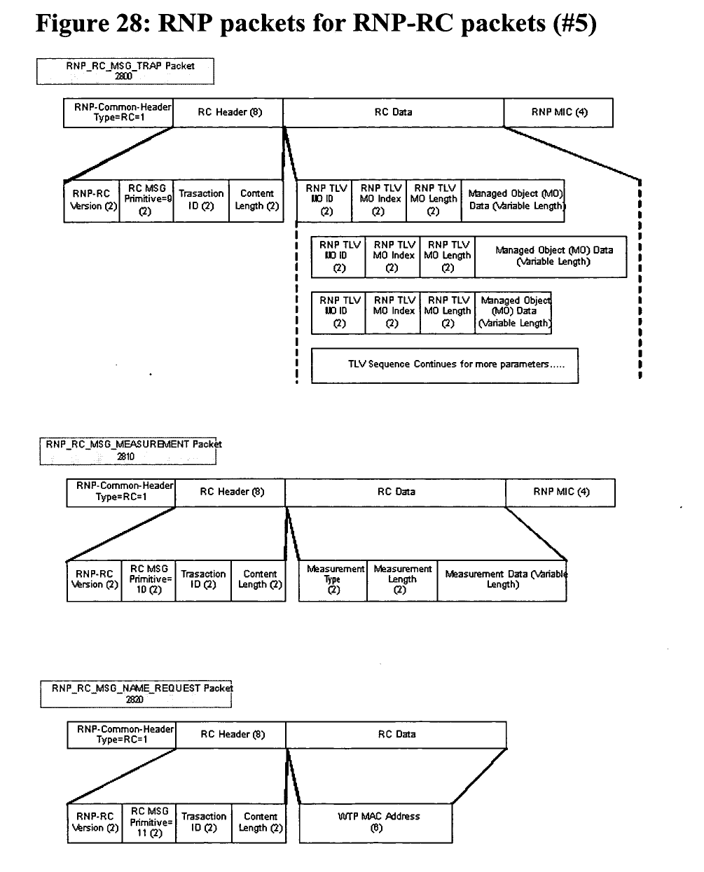

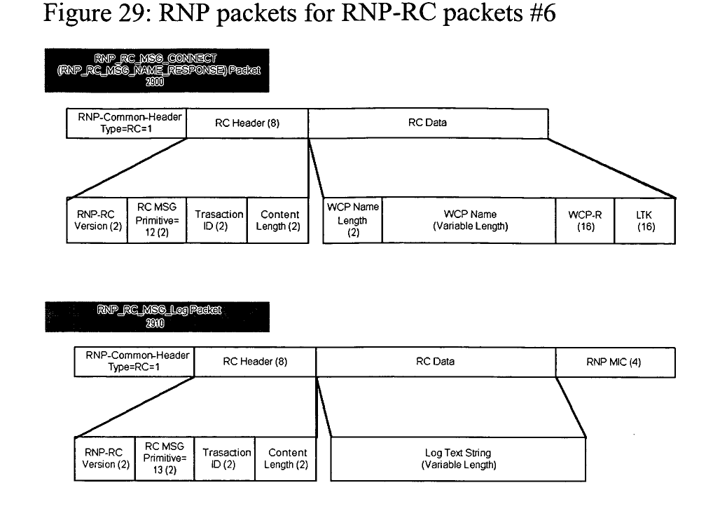

FIGS. 24 shows an embodiment of the RNP_RC_MSG_CAPABILITIES packet (2410) and the RNP_RC_MSG_ACCEPT packet (2420). FIG. 25 shows the RNP_RC_MSG_CONFIGURE packet (2500) and the RNP_RC_MSG_CONF_RESP packet (2510). FIG. 26 shows the RNP_RC_MSG_MO_SET packet (2600) and the RNP_RC_MSG_SET_RESP packet (2610). FIG. 27 shows the RNP_RC_MSG_MO_FET packet (2700) and RNP_RC_MSG_MO_GET_RESP (2710). FIG. 28 shows the RNP_RC_MSG_TRAP packet (2800), RNP_RC_MSG_MEASUREMENT packet (2810), and the RNP_RC_MSG_NAME_REQUEST packet (2820). FIG. 29 shows the RNP_RC_MSG_CONNECT packet (2900), and the RNP_RC_MSG_LogPacket (2910).

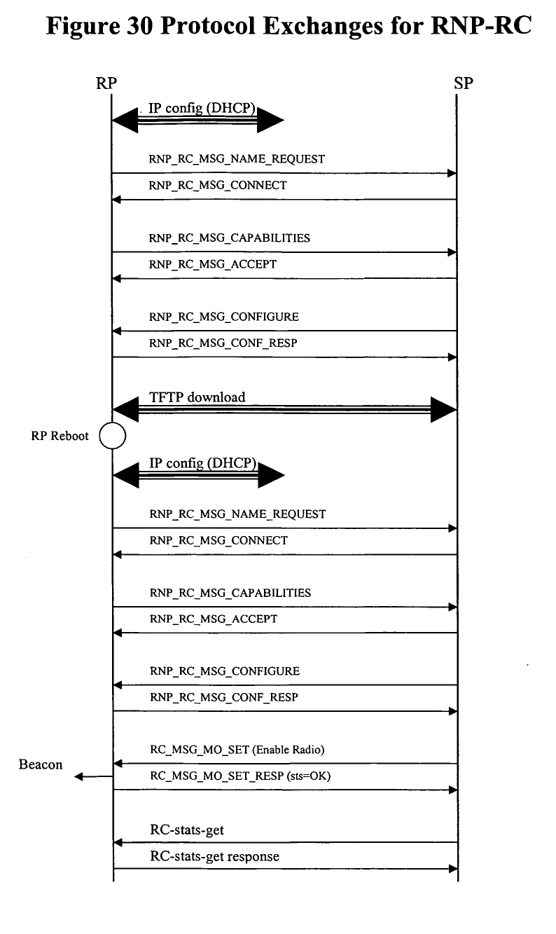

FIG. 30 shows a sample protocol exchange for the RNP_RC sub-protocol.

RNP-SM Primitives

| | | Reliable | |
|---|---|---|---|
| Primitive Name | Value | Delivery | Primitive Use |
| RNP_SM_MSG_CONNECT | 1 | YES | Sent by RP when it first associates to the SP to |
| | | | initialize the SM protocol for a particular BSS. |
| RNP_SM_MSG_ACK | 2 | NO | Acknowledges reception of the primitive. Contains |
| | | | RSID and Sequence # from the original message |
| RNP_SM_MSG_RNP_ERROR | 3 | NO | Delivers notifications about protocol errors and reason |
| | | | codes |
| RNP_SM_MSG_80211_MNG_FRAME | 4 | YES | Conveys 802.11 Management frames |
| | | | Encapsulates entire 802.11 Management frame |
| RNP_SM_MSG_DATA_PACKET | 5 | RP->SP NO* | Conveys 802.11 data packets, including 802.1x packets. |
| | | SP->RP YES | Encapsulates the entire 802.11 packet. *Note that the |
| | | | FIRST frame from a new station will be reliably |
| | | | transmitted from the RP to the SP. |
| RNP_SM_MSG_OOB_FRAME | 6 | NO | Sent by RP to deliver to the SP “Out Of the Blue” |
| | | | frames |
| | | | Encapsulates entire received frame |
| RNP_SM_MSG_STA_CONTEXT_{—} | 7 | YES | Sent by SP to get station context |
| GET | | | |
| RNP_SM_MSG_STA_CONTEXT_{—} | 8 | YES | Sent by RP to deliver station context to SP. Reply by |
| INFO | | | the RP to a context get message. |
| RNP_SM_MSG_STA_CONTEXT_{—} | 9 | YES | Sent by SP to modify station context in the RP |
| SET | | | |
| RNP_SM_MSG_STA_CONTEXT_{—} | 10 | YES | Sent by SP to delete station context in the RP |
| DELETE | | | |
| RNP_SM_MSG_STA_STAT_GET | 11 | NO | Sent by SP to request station statistics. |
| RNP_SM_MSG_STA_STAT_GET_{—} | 12 | NO | Sent by RP in response to a station stat get. |
| RESP | | | |
| RNP_SM_MSG_DISCONNECT | 13 | NO | Sent by either RP or SP to indicate that SM protocol is |
| | | | disconnecting and will need to reconnect in the future. |
| | | | sent by RP to SP when BSS has been disabled. |
| RNP_SM_MSG_STA_KEY_SET | 14 | YES | Sent by the SP to the RP to change or remove the |
| | | | encryption key for a station. |
| RNP_SM_MSG_GRP_KEY_SET | 15 | YES | Sent by the SP to the RP to change or remove a group |
| | | | key used to encrypt broadcast packets on the BSS. |

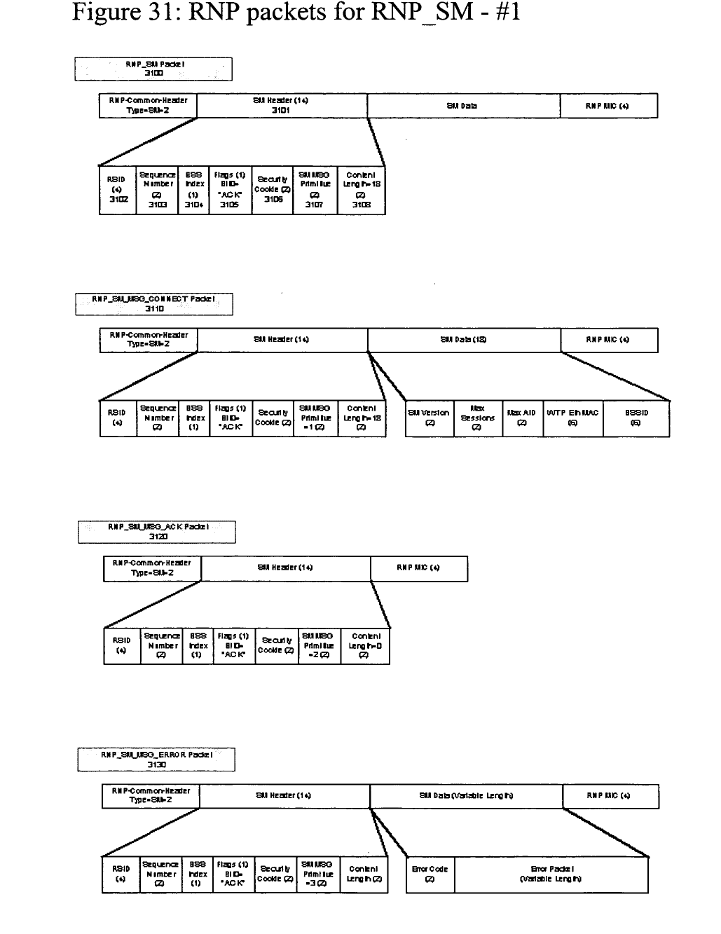

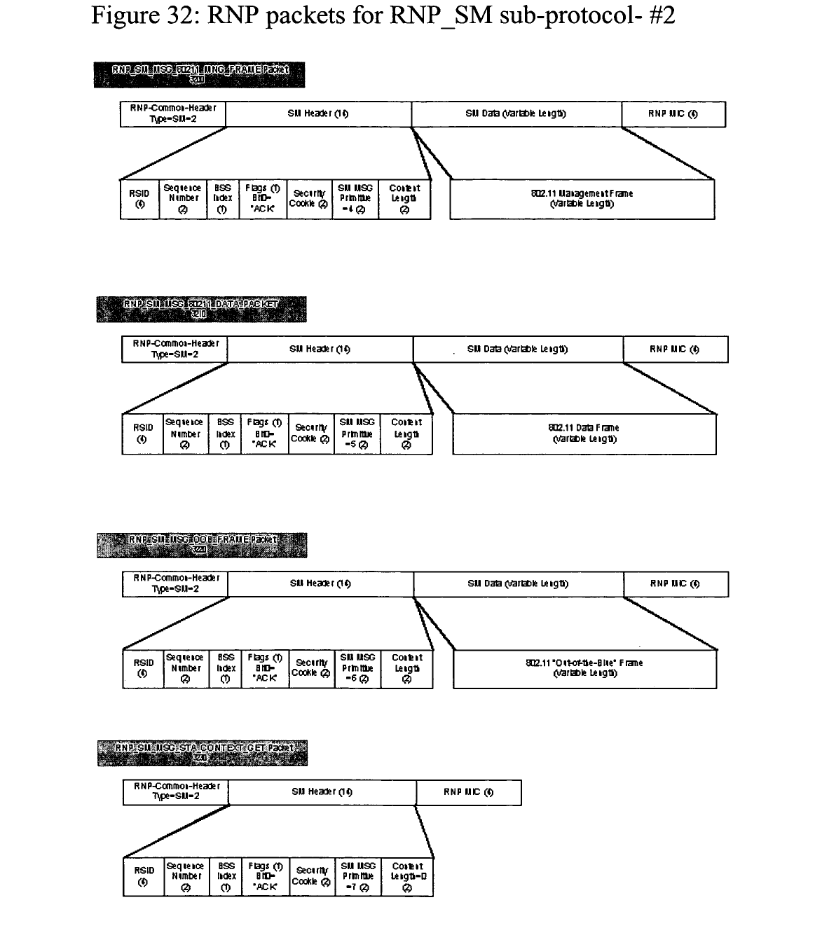

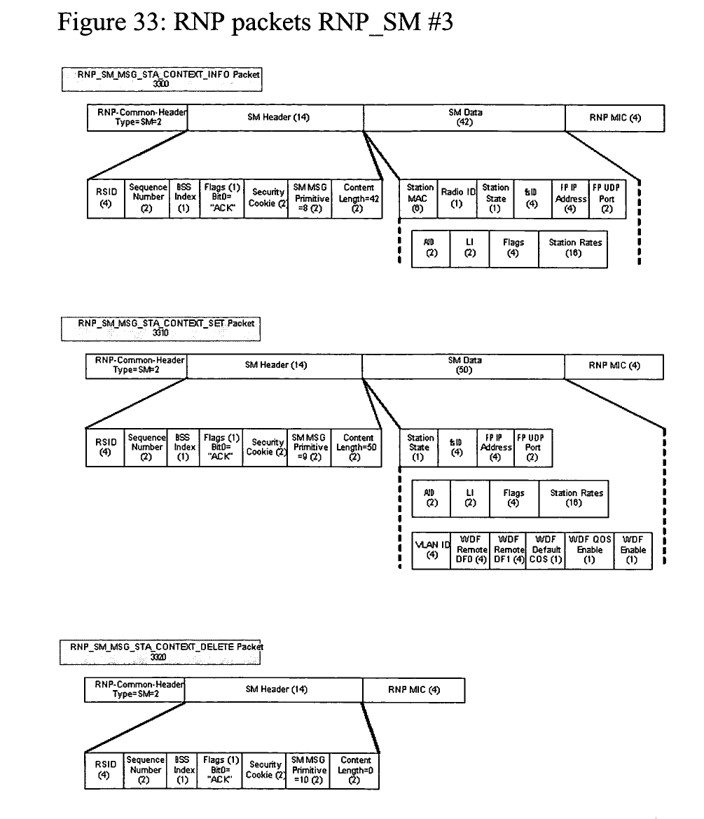

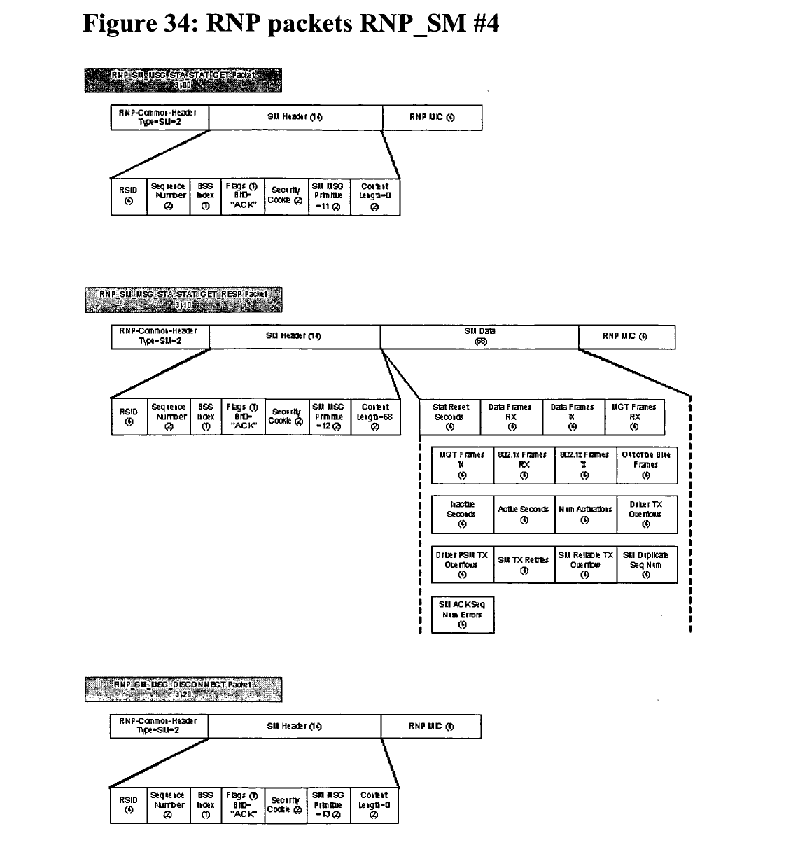

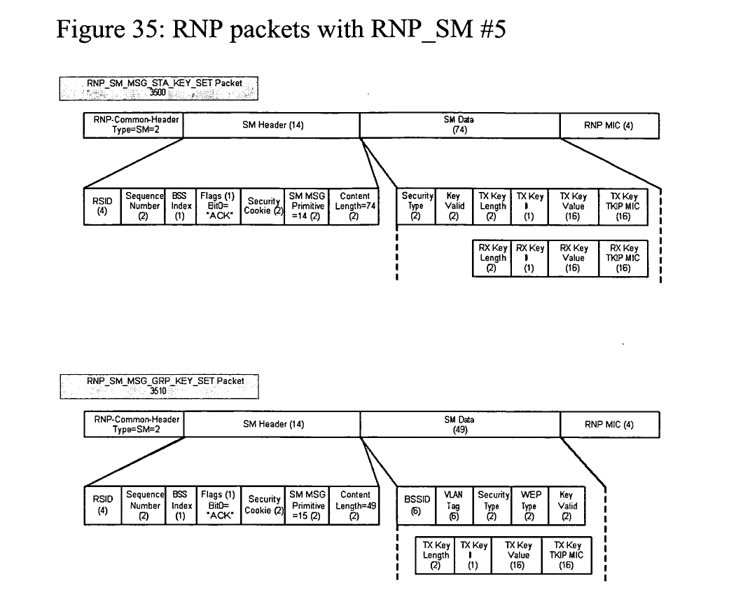

FIGS. 31 through 35 show an packet formats for the RNP-SM sub-protocol sub-streams packets.

RNP_DT Sub-Protocol

The current embodiment of the RNP-DT message does not support splitting the RNP-DT sub-protocol into sub-streams

RNP_DF Sub-Protocol

The DF-Server is a point that connects the tunnel to a wired network. The DF-Client is a point that interfaces the wireless Access Point (AP) to the tunnel. An embodiment of an DF-Client can be an AP. An embodiment of a DF-Server can be an AP or a standalone appliance. Each of these sub-protocol primitives have a field for a request/response. One end of the connection (DF-Server or DF-Client) sends a “request” message, and the remote end of the connection (DF-Server or DF-Client) sends a “response” message.

| | | Reliable | |
|---|---|---|---|
| Primitive Name | Value | Delivery | Primitive Use |
| RNP_DF_PATH_CHECK | 1 | NO | Test connectivity |
| | | | between |
| | | | the DF-client |
| | | | and DF-Server. |
| RNP_DF_OPEN | 2 | YES | Establish (Open) |
| | | | virtual connection |
| | | | between DF-Client |
| | | | and DF-Server. |
| RNP_DF_CLOSE | 3 | YES | Terminate virtual |
| | | | connection between |
| | | | DF-Client and |
| | | | DF-Server. |
| RNP_DF_RESET | 4 | YES | Abort (terminate |
| | | | abnormally) |
| | | | virtual connection |
| | | | between DF-Client |
| | | | and DF-Server. |
| RNP_DF_KEEPALIVE | 5 | YES | Periodic message |
| | | | to indicate |
| | | | active connection |
| | | | between |
| | | | DF-Client |
| RNP_DF_CONFIG | 6 | YES | Configure DF object in |
| | | | server memory. |
| RNP_DF_STATUS | 7 | YES | Get status of DF object |
| | | | in server memory. |

RNP-WP Sub-Protocol

The RNP-WP sub-protocol supports the Web Portal function. The Web Portal functions limits the traffic to information needed to exchange data with a Web Portal to obtain the correct information. The current embodiment of the RNP-WP sub-protocol does not have any sub-protocol primitives.

The benefits of this approach for providing secure layer 2 access to the enterprise network include:
Unified infrastructure.
Enterprises can utilize either lightweight or heavyweight access points.
Extends the layer 2 enterprise network to the home, and public Internet facilities.
Option for simultaneous access to both remote enterprise and local resources such as printers, IP fax services, etc.
Option for access to the Internet only through the enterprise to leverage enterprise-based IDS, firewall, and virus scanning.
Simultaneous co-existence of lightweight and heavyweight access points within the enterprise campus, including seamless mobility between these devices.
Standards based secure layer 2 wired connectivity.
Simpler VoWP to cellular roaming.

The present invention provides a unified infrastructure that allows enterprises to utilize the same wireless LAN switch for both local-campus wireless access as well as remote access. Unlike currently available remote connectivity solutions, separate infrastructures for LAN and WAN connectivity need not be deployed. For the IT staff, this saves both capital and operational expenditures, including a reduction in the amount of technical support required, because a wireless LAN deployment over the enterprise campus will work for remote access as well. For the end user, this means that the behaviors for remote connectivity and local enterprise connectivity will be the same. The unified infrastructure also means that layer 2 networking protocols and services are available for the remote user, thereby providing the full capability of the enterprise campus network to the remote users. This includes extending any policy-based layer 2 capability that the enterprise may have implemented within its campus to the remote users.

Enterprises can use either lightweight access points (which are more easily managed by the enterprise), heavyweight access points (less expensive and more ubiquitous at public Internet access facilities), or a combination of both. The lightweight access points can be deployed within the campus to give the enterprise centralized control of the local radio environment. For remote users, traditional heavyweight access points can be used in public Internet access settings. Enterprises may wish to use either heavyweight or lightweight access points for home and branch office applications, depending upon enterprise needs. Within the enterprise, a combination of existing heavyweight access points can be augmented with lightweight access points.

WiFi VPN can extend the enterprise network to employees' homes. Employees can open their laptops at home and immediately connect to the enterprise layer 2 network without the need to invoke special remote VPN client software. Employees may also utilize VoWLAN phones to enable voice communications from the enterprise to the employees' homes. Still further, employees can initiate voice communications utilizing enterprise voice infrastructure from the VoWLAN phone.

Like traditional layer 3 VPN solutions, a WiFi VPN for the branch office allows enterprises to realize significant cost savings by connecting the branches to the enterprise headquarters via an Internet connection, as opposed to an expensive leased line connection. Unlike traditional VPN solutions, a WiFi VPN operates at layer 2, so employees in branch offices can have access to the same legacy applications available on the enterprise campus. By extending the enterprise's existing layer 2 network, the invention also extends policy-based layer 2 networking from the enterprise and simplifies the IP addressing within the branch offices.

When employees are on the road and using a public Internet access facility such as a hotel broadband connection, or a hotspot, they typically must log into the public Internet facility using a browser, and then start their remote VPN client. Instead of this cumbersome process, the present invention allows a public Internet provider to negotiate a billing arrangement with the employees' enterprise to allow connectivity to the public Internet IP address and UDP port number of the enterprise's WiFi VPN presence on the Internet. The enterprise can then signal the successful connection of a WiFi VPN client to the provider for billing purposes. This functionality allows two individuals from different enterprises to simply open their PC lids at a hotspot, and they will each be automatically connected to their corporate facilities without performing a single keystroke or mouse movement.

One potential problem with layer 2 WiFi VPN enterprise connectivity occurs if all IP traffic is shunted through the layer 2 WiFi VPN connection. This limitation can be overcome through the use of virtual interface software that has the same operational behavior as existing, conventional VPN software, that takes the form of a WiFi VPN client. IP routing can be configured on the WiFi VPN client in the manner of existing layer 3 VPN clients so that devices reachable locally (such as printers, IP fax machines, etc.) using the physical wireless (or wired) interface are routed locally by the client.

Alternatively, if an enterprise wishes to prevent the wired or wireless interface from reaching local resources, then the WiFi VPN client can be used for all traffic by configuring the appropriate IP routing tables on the client device. This forces all traffic between the client hardware and the enterprise going out to the Internet to utilize the enterprise's Internet connection. As a result, enterprise tools such as IDS, IDP, firewall, and antivirus programs can be applied to remote users. This may be a desirable security model for enterprises seeking to control the software and agents that actually enter the enterprise's client hardware devices.

Another advantage of the WiFi VPN client is that it allows simultaneous coexistence between traditional heavyweight access points and lightweight access points. With a WiFi VPN client in accordance with the present invention, seamless roaming can be accomplished between heavyweight access points and lightweight access points, both connected to the same network of WLAN switches. In addition to roaming, all the wireless benefits described in the present invention apply to both heavyweight and lightweight access points.

The present invention is applicable both to wireless and wired LANs. When the virtual interface of the WiFi VPN client is connected to the wired LAN, the wireless LAN switch can serve as a encrypted wired switch to encrypted wired traffic using the same 802.1x, WPA, and 802.11i technology that is used to encrypted wireless LAN traffic.

A challenge with VoWLAN is determining how to integrate VoWLAN and cellular voice calls. With a WiFi VPN, the VoWLAN call can be terminated at the enterprise. One advantage of this mechanism is that any VoWLAN handset can be used at any hotspot, since it will connected back to the enterprise VoIP infrastructure using the WiFi VPN. This means that off-the-shelf VoWLAN handsets can be used with essentially any hotspot for VoWLAN, and that the handset user can be reachable anywhere in the world simply by dialing the enterprise extension of the handset user. Integration with the cellular network becomes a simple matter of forwarding calls from the cellular phone number of the handset to the DID number of the enterprise, and vice versa if the handset if out of range of a hotspot. This also has the advantage of allowing the same handset with the same cellular phone number to be used as an enterprise extension with multiple enterprises in a serial fashion, as in the case of a contractor/temporary employee.

Embodiments of the invention include a Remote Network Protocol (RNP) which has various advantages over existing protocols such as L2TP and GRE. In some embodiments, RNP uses separate UDP port numbers for controlling and monitoring the radio, the station authentication, and the station traffic. This reduces the computational load on the switch of classifying packets according to their contents. It also prevents a station authentication packet from blocking a data packet. The packets can instead be classified in hardware based on their port numbers, which improves performance. The UDP nature of the RNP is also very important since TCP has slow start mechanisms and additional processing overhead that increase computational requirements for the lightweight access point.

The RNP together with the switch architecture assumes that all time-insensitive 802.11 MAC layer operations will be performed on the WLAN switch, and that time-sensitive 802.11 operations will be performed on the lightweight access point. This split of 802.11 layer functionality allows the RNP protocol to be latency-tolerant across wide-area networks with varying latency. With the incorrect split, a similar approach cannot operate properly across a wide-area network. For data transfer, the RRP protocol uses low framing overhead to ensure high performance and low computational overhead on the lightweight access point. The low overhead also assists with performance on the WLAN switch.

In an embodiment of this invention, 802.11 frames from a wireless client station enter a RF/Wireless Mesh-based distribution system at an AP and are bridged and routed to the integration service portal via RF interfaces on other APs in the mesh. The system does not terminate 802.11i or other encryption on the AP where the station traffic enters the RF mesh. Instead the frames are bridged in the encrypted format via RNP over Wireless (802.11) interface until the point where it enters the wired network or a wireless LAN switch or an access controller or another device in the network that has the security state to decrypt the client traffic. This approach avoids hop-by-hop encryption that is specified by the current wireless standards and practice.

The approach of the RNP protocol with regard to reliability is also unique compared to L2TP and GRE. With generic protocols, all traffic is treated identically. In order to guarantee delivery of critical 802.11 and 802.1x authentication and association frames with legacy protocols, all packets must be somehow guaranteed delivery, which can add significant overhead and delay to data frames that do not need guaranteed delivery. If delivery is simply not guaranteed, then successful authentication to the network becomes less reliable, particularly across a wide-area public network such as the Internet in which there is typically a higher packet error rate. With the RNP approach, by contrast, application level delivery guarantees are maintained on the UDP port that transports station authentication information, and station traffic rides on a different UDP port without delivery guarantees for high performance. The RNP approach also is higher performance for authentication traffic, since it authenticates each message rather than implementing a TCP-like sliding window or piggybacking acknowledgements on top of return frames. Since multiple stations may be connected to the same lightweight access point, the concept of “streams” is used to demultiplex the different stations connected to a radio. This improves performance, because individual stations can be mapped to streams, and also removes the need to open up a new UDP port for every station connected to the lightweight access point.

The RNP is flexible, because the endpoints can terminate on different devices. For example, if the RNP-SM and RNP-DT originate on the client, the client has the WiFi VPN client software. With RNP-SM, RNP-DT, and RNP-RC originating from an access point, a lightweight access point is used. The termination of the RNP tunnels does not have to be restricted to a single wireless LAN switch. For instance, the RNP-RC may terminate on a different device than the RNP-SM, which may terminate on a different device than the RNP-DT. This would allow, for instance, a wireless LAN switch architecture in which one device is optimized to manage a large number of lightweight access points, another device is optimized to terminate 802.1x authentication, and another device is optimized to perform data encryption and forwarding.

The WiFi VPN client solves numerous problems. Without the WiFi VPN, it would ordinarily be necessary to load the RNP protocol into access points wherever WiFi VPN applications are deployed, including at branch offices, remote home office to enterprise connectivity, and hotspot connectivity. In a practical sense, this limits the ease of deployment of WiFi VPNs. With the WiFi VPN client, by contrast, deployment is much easier because existing heavyweight access points can be used without modification in the clear text (unencrypted) mode of operation to deliver traffic to the wireless LAN switch. The WiFi VPN client also enables encrypted wired LAN traffic by leveraging 802.11 security technology for wired LANs. Another LAN benefit to the WiFi VPN client is that a wireless station may connect to a network comprising a wireless LAN switch and a mix of heavyweight and lightweight access points. In this network, the movement of wireless stations from access point to access point is handled seamlessly. Other approaches with wireless LAN switches utilize IPSec or other layer 3 VPN termination at the wireless LAN switch and do not permit movement of a wireless station from a heavyweight access point to a lightweight access point.

To support WiFi VPN applications, the wireless LAN switch terminates both user authentication as well as the wireless LAN encryption algorithms. The different alternatives considered before selection of the current design are detailed in exhibit [ ]. Since no commercially available cipher products are available for high speed wireless LAN encryption ciphers such as RC4, a purpose-built FPGA provides application-specific cryptography.

Wireless LAN Switch or Controller architecture provides an 802.11i authenticator component that obtains the PMK based on current standards.

The PMK Sharing described in this invention allows the PMK to be shared across wireless network devices, and reduce roaming latency for applications such as Voice-over-IP (over Wireless) while
Preserving the trust binding between the authenticator, wireless client and the authentication server.
Preserving ability and flexibility to control wireless client access to the network. For example, the Authorization token based scheme allows an enterprise to prohibit roaming to a specific AP.

The WiFi VPN invention allows enterprises to share the WISP infrastructure. With this invention, a WISP can offer hotspot services, say using a subscription based business model to enterprises, while allowing them to control access to their networks. At the same time this mechanism also utilizes a single authentication for a given client access wherever the WISP provides its services. Furthermore it also allows different clients to use a single WISP infrastructure everywhere on the internet while securely accessing their respective enterprises.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A method of facilitating secure communications between an enterprise network and a user communicating over a wide-area network accessible to the enterprise network, the method comprising:
generating a set of encapsulated packets, generating the set of encapsulated packets further including encapsulating, within a first protocol, data packets originating with the user, wherein the user-originated data packets are encoded in a second protocol, and the second protocol is below the first protocol in a hierarchy of protocols;
transmitting the encapsulated packets to the enterprise network over the wide-area network;
receiving the encapsulated packets at the enterprise network;
un-encapsulating the encapsulated packets to retrieve the user-originated data packets encoded in the second protocol;
forwarding the user-originated data packets across the enterprise network via the second protocol.

2. The method of claim 1, wherein the hierarchy of protocols is an ISO hierarchy.

3. The method of claim 1, wherein the first protocol is a layer 3 protocol.

4. The method of claim 3, wherein the second protocol is a layer 2 protocol.

5. The method of claim 4 wherein the user communicates with the wide-area network using a wireless protocol.

6. The method of claim 5 wherein the wireless protocol is WiFi.

7. The method of claim 1 wherein the user communicates over a local area network using a wireless protocol.

8. The method of claim 7 wherein the wireless protocol is WiFi.

9. The method of claim 1 wherein first protocol is a WiFi VPN protocol that rides on top of UDP/IP.

10. The method of claim 1, further comprising:
encrypting the encapsulated packets prior to transmitting the encapsulated packets to the enterprise network.

11. The method of claim 10, further comprising:
after receiving the encapsulated packets, decrypting the encapsulated packets.
